(19) United States
(12) Patent Application Publication
(10) Pub. No.: US 2020/0143085 A1
(43) Pub. Date: May 7, 2020

(54) SYSTEM, BUSINESS AND TECHNICAL METHODS, AND ARTICLE OF MANUFACTURE FOR DESIGN, IMPLEMENTATION, AND USAGE OF INTERNET OF THINGS DEVICES AND INFRASTRUCTURE, SOCIAL MEDIA ARCHITECTURE AND GENERAL COMPUTING DEVICE SECURITY ADVANCEMENTS

(71) Applicant: JASON RYAN COONER, Pinson, AL (US)

(72) Inventor: JASON RYAN COONER, Pinson, AL (US)

(21) Appl. No.: 16/181,062

(22) Filed: Nov. 5, 2018

(51) Int. Cl. G06F 21/62; H04L 29/08; H04Q 9/00

(52) U.S. Cl. CPC G06F 21/6263; H04Q 9/00; H04L 67/12

(57) ABSTRACT

Non-invasive brain and body injury and vital sign assessment monitors, as well as methods for providing Internet-enabled care and recovery services for related conditions and injuries are disclosed. The sensors may be enclosed in a head wrap known as a “skull cap”, or they may be worn on other parts of the body such as the wrist or ankle. The present invention relates to brain and body assessment monitors, and relates to detection of brain trauma, stroke, and other related injuries sustained during physical activity. The invention also covers providing Internet enabled healthcare provider care associated with such injuries as a consolidated system. The biometric sensor arrays can be used as part of an Internet of Things system that may utilize a blockchain or distributed ledger technology for storage of sensor data.

Businesses that lag behind the technology curve may never be able to bridge the gap. As a general example, Airborne Express used to be one of the top three overnight shipping companies, competing directly with UPS and FedEx. However, they did not see technology as a strategic enabler and failed to keep pace with their key competitors. Eventually, the chasm was so great that they were no longer able to compete on service or price and had to sell the company.

IoT has the potential of being the most disruptive and transformative technology to affect both IT and business in years. The IoT revolution creates unprecedented opportunities for businesses to provide enhanced customer experiences, build new customer communities, create a new generation of products, provide advertising that is totally relevant to the targeted audience, improve operations and reduce costs. Today's customers of digital devices expect smarter, connected and technologically advanced systems, and the companies that sell them expect to have data analytics that enable them to achieve operational efficiencies.

### SUMMARY OF THE INVENTION

### How Businesses are Harnessing IoT

Here are a few examples of how companies are gaining a competitive edge and changing their businesses through IoT.

The American cruise ship company Royal Caribbean used IoT to reduce costs, increase revenue and improve workflows. By integrating sensors and their onboard point-of-sale systems, tablets, signage, TV, photo gallery and ticketing systems—then harnessing the resulting “ocean” of data—they now have a better understanding of their guests' needs and can tailor and personalize guest experiences. They have also been able to streamline the food temperature inspection process and cut the temperature check times by 60%. Royal Caribbean now has an intelligent system that captures and makes sense of data flowing across systems at every level of the ship.

IoT is also affecting our global food supply. Farmers today are under significant pressure to do more with less, all while managing greater operational complexity. As a result, John Deere began connecting its farm equipment to a mobile platform, giving farmers and their dealers remote access to fleet location and utilization as well as diagnostic data for each machine. They are also using networked sensors combined with historical and real-time data on weather, soil conditions and crop status to ensure the right crops are planted at the right time and place.

### Why Companies Need IoT

IoT provides a tremendous opportunity across all segments of a corporate entity. There are many potential scenarios that could be considered, including:
Creating new customer experiences and customer communities (Customer Service, Consumer Products)
Driving operational efficiencies, predictive maintenance and more intelligent supply chains across the organization
Enhancing the fan/viewer experience for athletic events using biometric sensors on participating athletes (Media Networks)
Driving automation/efficiencies in manufacturing facilities

Archetype Biometrics, LLC has been developing wearable biometric platforms to assist in indicating injuries in sport with a specific focus on concussions, or traumatic brain injuries (TBI). The latest platform being marketed under the name PlayerMD represents the most advanced accelerometer-based implementation for indicating TBI currently available. However, the use of accelerometers to detect TBI is more or less predictive analysis of when the injury may occur.

In an attempt to develop a true detection mechanism for TBI, Archetype has been developing several new techniques that may serve to identify actual tissue damage consistent with TBI as it occurs in the field in a real-time, non-invasive manner. Archetype has designed and patented several techniques which can be used to potentially achieve this and is now ready to conduct tests on live specimens in an attempt to finalize development of the technology for field use. These techniques include passive identification of actual tissue damage through a number of biological responses to the injury as it occurs. Such responses include:
1. Acoustical response from the tissues shearing and compressing
2. Streaming potential voltage release
3. Piezoelectric and pyroelectric effect voltage release
4. Magnetic field emission from the creation of such voltages
5. Potential light and infrared wave emission from the chemical response to the tissues being damaged

The techniques outlined above have plausible research previously conducted to support their viability. To gain a better understanding of the research conducted over the past century related to this, feel free to review any of the documents listed in the reference section at the end of this document. The cited works, along with Archetype's own initial lab testing, are the basis for pursuing this research to identify TBI. Although there were no specific references to using these techniques for injury detection in any of the referenced documents, they do provide substantial proof that each of these techniques is viable to detect injuries specific to TBI when combined with PlayerMD, Archetype's wearable biometric platform. The first 163 cited papers reference a great deal of the generalized research related to this proposal, while the last 18 cited texts are specific to streaming potentials in the human body and are more relevant to this discussion.

### BRIEF DESCRIPTION OF THE DRAWINGS

FIG. 1: Potential Internet of Things (IoT) Edge Hardware Layout Including Sensor Devices, Edge Routers, and an Edge Gateway with Cellular, Satellite and/or LoRaWAN or SigFox Capability Built In for Internet Access

FIG. 2: Potential Internet of Things (IoT) Edge Hardware Layout Including Sensor Devices, Edge Routers, and an Edge Gateway to Local WiFi Gateway for Internet Access

FIG. 3: Potential Hardware Design Layout for Combination Sport Performance Monitoring Headgear with Audio Communications Capability

### DETAILED DESCRIPTION

Biological systems often generate rapidly changing electric and magnetic fields in biological systems, i.e. high frequency endogenous electromagnetic phenomena in living cells. Unlike the events studied by the electrophysiology, the generating mechanism of bioelectrodynamic phenomenon is not connected with currents of ions and its frequency is typically much higher. Examples include vibrations of electrically polar intracellular structures and non-thermal emission of photons as a result of metabolic activity. Bioelectrodynamic effects have been experimentally proven in the optical range of electromagnetic spectrum. In particular, spontaneous emission of photons by living cells, with intensity significantly higher than corresponds to emission by thermal radiation, has been repeatedly reported by different research groups. For acoustic and radio emissions, there is indirect evidence about their existence.

Bioelectrical signals are very low amplitude and low frequency electrical signals that are generated in biologic organisms, including humans. Bioelectrical signals are generated from the complex self-regulatory system and can be measured through changes in electrical potential across a specialized tissue, organ, or cell system like the nervous system or heart. Thus, among the most medically relevant bioelectrical signals are: electroencephalogram (EEG), electrocardiogram (ECG), electromyogram (EMG), electrooculography (EOG), galvanic skin response (GSR), and magnetoencephalogram (MEG).

Electrical activity in the brain is measured by electroencephalography (EEG), which is an electrophysiological monitoring method. It is typically noninvasive, with the electrodes placed along the scalp, although invasive electrodes are sometimes used such as in electrocorticography. EEG measures voltage fluctuations resulting from ionic current within the neurons of the brain. In clinical contexts, EEG refers to the recording of the brain's spontaneous electrical activity over a period of time, as recorded from multiple electrodes placed on the scalp. Diagnostic applications generally focus either on event-related potentials or on the spectral content of EEG. The former investigates potential fluctuations time locked to an event like stimulus onset or button press. The latter analyses the type of neural oscillations (popularly called “brain waves”) that can be observed in EEG signals in the frequency domain.

Electrical activity in the brain also generates magnetic fields. As such, magnetoencephalography (MEG) is a functional neuroimaging technique for mapping brain activity by recording magnetic fields produced from the electrical currents occurring in the brain. Arrays of SQUIDs (superconducting quantum interference devices) are currently the most common magnetometer, while the SERF (spin exchange relaxation-free) magnetometer is being investigated for future machines. Applications of MEG include basic research into perceptual and cognitive brain processes, localizing regions affected by pathology before surgical removal, determining the function of various parts of the brain, and neurofeedback. This can be applied in a clinical setting to find locations of abnormalities as well as in an experimental setting to simply measure brain activity.

### Biological Mechanics of TBI

To better understand the types of biological outlays we want to isolate for TBI detection, we should better understand the physical properties of the injury and its mechanics. The brain itself is a gelatinous structure that is spongy in nature. The Cerebrospinal fluid (CSF) that surrounds the brain is a more dense material that acts to hold the brain in place and serves as a cushioning mechanism for the brain inside the skull. The skull bone itself is somewhat jagged on the interior surface facing the brain. The medical community classifies TBI to be one of two basic types, focal or diffuse. Focal injuries are more consistent with cerebral contusion, or bruising of the brain, as the brain impacts the skull wall. Diffuse injuries (usually referred to as diffuse axonal injury, or DAI) are where damage occurs across a wider area of the brain and are more consistent with the shearing of brain tissue and/or combinations of bruising and shearing.

Both focal and diffuse TBI and the mechanics of how they occur are explained further in a concept called “coup contracoup”, or acceleration/deceleration injury. A coup injury occurs under the site of impact with an object, and a contracoup injury occurs on the side opposite the area that was impacted. Coup and contracoup injuries can occur individually or together. When a moving object impacts the stationary head, coup injuries are typical, while contracoup injuries are produced when the moving head strikes a stationary object. In a contracoup injury, the head stops abruptly and the brain collides with the inside of the skull. The coup injury may also be caused when, during an

impact, the skull is temporarily bent inward and impacts the brain. When the skull bends inward, it may set the brain into motion, causing it to collide with the skull opposite side and resulting in a contracoup injury.

The injuries can also be caused by acceleration or deceleration alone, in the absence of an impact. In injuries associated with acceleration or deceleration but with no external impact, the brain is thought to bounce off the inside of the skull and hit the opposite side, potentially resulting in both coup and contracoup injuries. In addition to the skull, the brain may also impact the tentorium to cause a coup injury. Cerebrospinal fluid (CSF) is also implicated in the mechanism of coup and contracoup injuries. One explanation for the contracoup phenomenon is that CSF, which is denser than the brain, rushes to the area of impact during the injury, forcing the brain back into the other side of the skull. If this is the case, the contracoup impact happens first.

Contracoup contusions are particularly common in the lower part of the frontal lobes and the front part of the temporal lobes. A 1978 study found that the contracoup mechanism was responsible for most of the brain lesions such as contusions and hematomas occurring in the temporal lobes of injured individuals. Injuries that occur in body parts other than the brain, such as the lens of the eye, the lung, the skull and other bones, may also be labeled “contracoup”. Due to this understanding, we believe that the focus of the audio patterns should be placed on listening for various contracoup audio signatures as they may be the determinate for the majority of actual TBI tissue damage.

Unlike focal brain trauma that occurs due to direct impact and deformation of the brain, DAI is the result of traumatic shearing forces that occur when the head is rapidly accelerated or decelerated. It usually results from rotational forces or severe deceleration.

The major cause of damage in DAI is the disruption of axons, the neural processes that allow one neuron to communicate with another. Tracts of axons, which appear white due to myelination, are referred to as white matter.

Acceleration causes shearing injury, which refers to damage inflicted as tissue slides over other tissue. When the brain is accelerated, parts of the brain having differing densities and distances from the axis of rotation slide over one another. This effect stretches axons that traverse junctions between areas of different density, especially at junctions between white and grey matter. Two thirds of DAI lesions occur in areas where grey and white matter meet. Lesions typically exist in the white matter of brains injured by DAI; these lesions vary in size from about 1-15 mm and are distributed in a characteristic way. DAI most commonly affects white matter in areas including the brain stem, the corpus callosum, and the cerebral hemispheres. The lobes of the brain most likely to be injured during DAI are the frontal and temporal lobes. Other common locations for DAI include the white matter in the cerebral cortex, the corpus callosum, the superior cerebral peduncles, basal ganglia, thalamus, and deep hemispheric nuclei. These areas may be more easily damaged because of the difference in density between them and the rest of the brain.

To better understand the post-traumatic effects of TBI from a molecular perspective, we provide the following paraphrased comments from the article “WHAT HAPPENS TO A FOOTBALL PLAYER′S BRAIN DURING A CONCUSSION? INSIDE THE INJURY THAT COULD DESTROY THE NFL” By Matt Giles:

Neurotransmitters—chemicals that allow neurons to communicate with each other—are released, but since the trauma is so great, these neurotransmitters are chaotic and rendered effectively useless. At the same time, the new membranes surrounding the brain's neuronal cells stretch so thin that ions like potassium and sodium flow out of the neurons and into the fluid-packed extracellular space. These ions are quickly replaced by calcium, which flows into the cell and basically paralyzes the neuron.

The cell is unable to transmit nerve impulses. So what you have is a cell that is alive, but is greatly impaired and nonfunctioning. Microseconds after the ion chemical reaction, nerve cells and fibers start to stretch. Once the blood vessels in those parts break, microscopic hemorrhages occur. Doctors using specialty MRI scans have seen these ruptures in injured NFL players as tiny holes where vessels have bled out. If the vessels bleed into the brain's tissue, the fluid could kill neurons, which can already be in bad shape from an impact.

Scientists do not currently know how to measure the number of cells injured in a concussion. Just seconds after an impact, the cascade of ions fleeing his nerve cells continues. That exodus will likely remain steady for days (if not weeks or months) afterward. Almost instantly, there is an inflammatory response to address the dysfunction in the nerve cells. Other cells, known as microglia, bombard the affected brain areas and create inflammation to plug the leaking fluids. The symptoms can last from a week to ten days (80 percent of concussions) to a month (10 percent).

### Electromagnetic and Chemical Properties of Brain and Skull Tissue

### Piezoelectric Effect and Streaming Potential of Bone, Tendon, Cartilage, and DNA

To quote Fukada, whom the others regard as a pioneer in bioelectrodynamics, “Stress-induced electricity in bone is caused by both piezoelectricity in collagen and streaming potential in microcanals in bone”. Studies on piezoelectricity and pyroelectricity in polymers were initiated in materials of biological origin. A variety of polysaccharides, proteins and DNA were found to exhibit piezoelectricity. Synthetic polymers such as polypeptides and optically active polymers were also found to be piezoelectric. The piezoelectricity and pyroelectricity in bone and tendon aroused interest in orthopedists and led to studies on the electrical stimulation of osteogenic system. The discovery of large piezoelectricity and hold polyvinylidine fluoride open the new field of research towards ferroelectric polymers. The Curie temperature was confirmed in the copolymers of vinylidine fluoride and trifluoroethylene. The characteristic changes of molecular confirmation and associated crystalline structure were revealed at the temperature range of the phase transition. Piezoelectric and ferroelectric like properties were found in the copolymers of vinylidenecyanide and vinylacetate, which are amorphous and transparent. Studies of ferroelectric polymers originated in the investigation of piezoelectric and pyroelectric properties of both biological and synthetic polymers. One of the early studies was piezoelectricity and pyroelectricity in wood and hair (Martin, 1941). Bundles of wood or hair were joined together by shellac keeping the tip and root in the same direction. When the bundles were compressed in the direction of orientation or cooled down to liquid-air temperature, an electric potential of 1 or 10 Volts was observed between the tip and root. Russian investigators carried out extensive research on the piezoelectricity of wood (Bazhenov, 1959). Shear stress applied to the oriented cellulose crystal lights produced a piezoelectric polarization. The converse effect, that is, elastin strain produced by an applied electric field was also verified (Fukada, 1955). The symmetry of the structure would is ascribed to D_{∞}(∞2).

It is well-known that the symmetry of crystals can be classified and 32 point groups, among which 20 exhibit piezoelectricity, and 10 exhibit pyroelectricity. Besides these, three possible symmetries were predicted for a uniaxial oriented system of crystal lights such as in diesel electric ceramics, in other words, a transversely isotropic body (Shubnikov, 1946; Marutake, 1958). The piezoelectric matrices for the three groups are as follows:

$${D}_{∞} ( ∞ 2 ) group [ \begin{matrix}0 & 0 & 0 & d 14 & 0 & 0 \\ 0 & 0 & 0 & 0 & - d 14 & 0 \\ 0 & 0 & 0 & 0 & 0 & 0\end{matrix} ]$$

$${C}_{∞} ( ∞ ) group [ \begin{matrix}0 & 0 & 0 & d 14 & d 15 & 0 \\ 0 & 0 & 0 & d 15 & - d 14 & 0 \\ d 31 & d 31 & d 31 & 0 & 0 & 0\end{matrix} ]$$

$${D}_{∞} ( ∞ m ) group [ \begin{matrix}0 & 0 & 0 & 0 & d 15 & 0 \\ 0 & 0 & 0 & d 15 & 0 & 0 \\ 0 & 0 & 0 & 0 & 0 & 0\end{matrix} ]$$

In 1953, Yasuda discovered that if a long bone, such as a femur, is subjected to bending deformation, the electric potential is produced. Sakata and Yasuda (1957, 1964) found subsequent shear and longitudinal piezoelectricity in bone and tendon. Laying (1966) observed pyroelectricity in bone and tendon. The symmetry of the structure of bone belongs to C_{∞}(∞). These works stimulated the investigations of stress—generated potential in bone and also studies of electrical stimulation of osteogenesis.

Later, a variety of biological polymers were found to exhibit piezoelectricity, for example, cellulose and its derivatives, polysaccharides such as chiten, and amylose, and proteins such as collagen, keratin, actin, myosin, silkfibroin, and fibrin (Fukada, 1982, 1983). The effects have also been identified in DNA and its dependence on temperature and hydration have also been demonstrated (Fukada and Ando, 1972).

Piezoelectricity has been found in a number of synthetic polymers including polyaminoacids and their derivatives, and in polyhydroxybutyrates and their copolymers. The sign of the piezoelectric constant is determined by the chirality of the atomic group with an optical activity L or D. The piezoelectric polarization is related to the stress—induced internal rotation of the chiral and polar atomic groups in the polymer molecule (Fukada, 1974).

The origin of piezoelectricity and pyroelectricity in poled polymers is ascribed to two mechanisms (Hayakawa and Wada, 1973; Wada and Hayakawa, 1976; Wada, 1982; Broadhurst, et al., 1978, 1980s; Furukawa et al., 1984). The first mechanism is called the dimensional effect. If the film is transversely stretched or cooled and the residual polarization in the film is unchanged, decrease the thickness of the film increases the induced charge in the electrodes on the surface of the film. The piezoelectric stress constant (polarization/strain) due to the effect is given by the product of Poisson's ratio times the residual polarization. The second mechanism is the intrinsic piece of electricity or pyroelectricity in the crystalline phase, which includes oriented polymer molecules in the non-crystalline phase. The residual polarization is changed by stress or temperature. The piezoelectric constant in the crystalline phase is determined by the product of the electrostriction constant times residual polarization. A hysteresis curve between the electric displacement and applied electric field has been observed by many authors (Tamura et al., 1974). However the possibility of movement of ions in the noncrystalline phase could not be ruled out. Hysteresis loops in the piezoelectric constant and the pyroelectric constant against biasing electric field were also clearly observed.

There has been a recent study conducted by XU LianYun, HOU ZhenDe & WANG Hong to determine the streaming potential voltage releases of wet bone under pressure as it would exist in vivo. The study states that when load is applied to bone, it deforms and causes fluid pressure to build up in bone. The pressure gradient between different portions of the bone microchannels drives fluid flow through them. This kind of bone fluid flow can induces the streaming potentials which are considered to play a role for bone remodeling. Aimed to determine the impact of ribbed rough inner surfaces of the microchannels on the streaming potentials, streaming potentials were measured as bone fluid flowed through the microspaces of thin cylinder bone samples under different pressure loading rates. The results show that the streaming potentials decrease with the increase of the pressure loading rates. A digital simulation calculation was performed and the results demonstrated that there were turbulent flows near the inner wall surfaces, which making the streaming potentials smaller in bone microchannels. Based on this research, we believe it will be possible to measure piezoelectric, pyroelectric, and streaming potential outlay for not only measuring overall brain activity, but to also utilize these properties in detecting subdural hematomas and possible swelling progression.

### Neurotransmission and Synaptic Impulses

Neurotransmission is the biochemical process by which neurons communicate with each other. Signaling molecules (called neurotransmitters) are released by the axon terminal of a neuron (the presynaptic neuron), which then bind to and activate receptors on the dendrites of another neuron (the postsynaptic neuron). In response to an action potential (or in some cases, graded electrical potential), a neurotransmitter is released at the presynaptic terminal. The released neurotransmitter then moves across the synapse and binds with receptors in the postsynaptic neuron. Binding of neurotransmitters may influence the postsynaptic neuron in either an inhibitory or excitatory way. The binding of neurotransmitters to receptors in the postsynaptic neuron can trigger either short term changes, such as changes in the membrane potential called postsynaptic potentials, or longer term changes by the activation of signaling cascades. Thus, neurotransmission relies upon: the availability of the neurotransmitter; the release of the neurotransmitter; the connection made between the postsynaptic receptor by the neurotransmitter; activity from the postsynaptic cell; and the subsequent removal or deactivation of the neurotransmitter.

### Proposed Lab Testing to Detect TBI

### Acoustical Response

As the mechanics of the injury itself are considered, one can deduce that several observations can assist development of a system that will detect TBI as it occurs through audio signal analysis. First, the brain bouncing inside the skull as occurs in the “coup-contracoup” scenario could sound a lot like hitting your palm against a watermelon. Second, as a leading neurologist proposed, the shearing of brain tissue as it is pushed across the jagged internal edge of the skull wall may sound a lot like the beaching of an ocean wave. Third, the microphones could be placed in a grid arrangement around those regions to gain more sensitivity since most TBI damage seems to occur in the lower part of the frontal lobes and front part of temporal lobes. This could serve to also provide the specific location(s) and extent of the tissue damage, as well as assist in choosing better care, recovery, and reintegration programs for the patient. And last, human bone acts as a natural resonator/amplifier for audio waves. Due to this, the ideal location for listening to DAI at the base of the brain and potentially to the entire brain cavity may be to place additional and potentially more sensitive microphones against the bone behind the ear pointing toward the interior of the brain. This may allow us to clearly hear audio resonations specific to TBI throughout the brain cavity regardless of where they occur.

The overall testing setup for acoustics should use a set of four balanced Earthworks MC-30 or 50 measurement microphones to detect the acoustical patterns created during a TBI. One of the reasons for choosing Earthworks microphones is because their microphones were chosen by NASA to detect faults in rocket propulsion fuselages. They have a range 12 of 5 to 30 kHz, or 3 to 50 kHz respectively with a sample rate of 50 microseconds per division. In addition, the recording hardware needs to be capable of recording at 192 kHz. This is the minimum acceptable acoustical recording quality whereby all noise can be removed from the original signal without compromising the quality of the acoustical signals of interest, according to Earthworks. After testing is completed, Earthwork's lead engineer has agreed to signal analyze the data and separate all obvious channels of acoustical resignation for further analysis. We believe this will render the desired results. If successful, it is our belief that acoustical resonations will not only allow us to determine the severity of the injury, but in effect identify the amount of damage done per tissue type within the human head.

### Piezoelectric, Pyroelectric, Streaming Potential, and Magnetic Field Response

Based on current information and previous research, we believe testing should consider two aspects from piezoelectric, pyroelectric, and streaming potential voltage outlay. One aspect should be short range voltage analysis (detection within a few millimeters) of the skull itself for purposes of identifying and assessing subdural hematoma. The second aspect is extended range (3 feet) voltage detection that can scan the entire brain's activity to better determine overall damage done during impact. This modeling could be done with voltmeters, but should be restricted to a specific range and allow for a minimum of microvolts in precision. We also believe that there will be significant magnetic field spikes associated with both the electrical and chemical outlays associated with TBI, and those changes should also be recorded with high-sensitivity magnetometers. We recommend magnetometers that will detect at least down to a microTesla if not nanoTesla for this testing, as that should be enough to detect anomalies consistent with the TBI damage.

In addition, we believe that utilizing an fMRI imaging system to analyze impacts in real-time by simply turning on the recording mechanism to assess the acoustical patterns created during TBI may be a highly precise means by which to capture both magnetic and acoustic resonations from TBI. Based on our assessments, utilizing a MEG imaging system may also be very beneficial to analyzing biomarkers for TBI in this regard.

### Neurotransmission and Synaptic Impulse Response

As stated in the introduction, further study of living cells has revealed that under certain conditions, such as cell growth and mitosis, living cells may also transmit ultra-weak high-frequency electromagnetic waves (photons) (e.g., a few hundred photons per cm2 per second at near infrared frequencies), the intensity of which depends on functional status of the cells. Furthermore, it has been shown that cells in culture might transmit and receive signals carried by EM radiation, which may control the orientation and migration of the cells. However, the origin and putative roles of this “rudimentary cell vision” are largely unknown. Based on this, we believe we should also place several infrared sensors around test subject in an attempt to detect any of the visible light or infrared waves that may escape during impact.

### Recommended Equipment Needed for Testing

In order to perform the above lab testing to further develop an identification technique for TBI, we recommend the following equipment and test primates:
1. Access to an fMRI machine to scan primates before and after testing to confirm TBI was imparted during the test. This can be done offsite, or if a MEG machine isn't available, we may want to use the fMRI machine to not only confirm damage but record the magnetic field changes during testing. Further explanation can be provided if these instructions aren't clear.
2. Access to a Diffuse Tensor Imaging machine to map nerve activity before and after testing to further confirm damage was imparted.
3. Access to a MEG imaging machine to use on site during testing for magnetic field outlay during impacts.
4. Four Earthworks MC30 or MC50s, preferably two sets of matched pairs.
5. A studio quality recording stack that can record raw acoustical signals at 192 MHz.
6. Five infrared sensors that will record light emissions as well as temperature outlays.
7. Five voltage sensors that are adjusted to only detect voltage increases at the surface of the skull.
8. Five voltage sensors that will pick up voltage outlays several feet away so that voltage changes throughout the skull can be detected.
9. And stands needed to hold sensors in a stable position around the head of the test primate during testing.
10. Primates for testing. Multiple samples taken from 5 to 10 primates should be sufficient to make reasonable assessments as to what will be needed to detect TBI in the field.
   Means to Manufacture Results into Accelerometer Based Skullcap

The medical neuroscience industry has been actively seeking to develop a technique that will actually detect traumatic brain injury (TBI) as it occurs. However, all previous attempts haven't resulted in any markers, bio or otherwise, that would conclusively detect the tissue damage as it occurs. We reviewed the injury in detail and assessed that TBI is caused by two primary events. Either the head is impacted and the brain is slammed against the inside of the skull causing the brain to bruise, or the head is impacted in a manner that causes brain tissue to shear, which results in tissue being torn.

After years of researching the issue, it finally became apparent that one aspect of the injury could be monitored in real-time in a non-obtrusive wearable manner that may accurately detect TBI as it occurs is acoustical response. We believe there are specific sound resonations that are produced during the brain bruising and/or shearing that could be listened for by a headgear design implemented with microphones. Considering that pretty much all human brain tissue is of a certain density, cerebrospinal fluids (CSFs) around the brain are of an identical chemical structure, and skulls are all made of course of bone, there should be some highly unique sound resonations that occur when tissue shears or the brain impacts the inside of the skull. In other words, if we put directional short range audio receivers in a grid pattern around the skull pointed toward the brain of the athlete that would listen for specific sound wavelengths and specific ranges of sound wavelengths that correspond to TBI events, one can hypothesize that this technique should result in a highly accurate indication that tissue damage consistent with TBI has occurred.

Injuries to the brain can be life-threatening. Normally the skull protects the brain from damage through its hard unyieldingness; the skull is one of the least deformable structures found in nature with it needing the force of about 1 ton to reduce the diameter of the skull by 1 cm. In some cases, however, of head injury, there can be raised intracranial pressure through mechanisms such as a subdural hematoma. In these cases the raised intracranial pressure can cause herniation of the brain out of the foramen magnum (“coning”) because there is no space for the brain to expand; this can result in significant brain damage or death unless an urgent operation is performed to relieve the pressure. This is why patients with concussion must be watched extremely carefully.

As the mechanics of the injury itself are considered, one can deduce that several observations can assist development of a system that will detect TBI as it occurs through audio signal analysis. First, the brain bouncing inside the skull as occurs in the “coup-contracoup” scenario could sound a lot like hitting your palm against a watermelon. Second, as a leading neurologist proposed, the shearing of brain tissue as it is pushed across the jagged internal edge of the skull wall may sound a lot like the beaching of an ocean wave. Third, the microphones could be placed in a grid arrangement around those regions to gain more sensitivity since most TBI damage seems to occur in the lower part of the frontal lobes and front part of temporal lobes. This could serve to also provide the specific location(s) and extent of the tissue damage, as well as assist in choosing better care, recovery, and reintegration programs for the patient. And last, human bone acts as a natural resonator/amplifier for audio waves. Due to this, the ideal location for listening to DAI at the base of the brain as well as potentially the entire brain cavity may be to place additional and potentially more sensitive microphones against the bone behind the ear pointing toward the interior of the brain. This may allow us to clearly hear audio resonations specific to TBI throughout the brain cavity regardless of where they occur.

We should also consider various microphone technologies in the design of this audio detection system. One microphone type that may be considered is the electret condenser microphone, which is the primary type of microphone used in cell phones, PDAs and computers. Electret condenser microphones have historically been considered low-quality and are therefore very inexpensive, but newer models are achieving quality in noise reduction and clarity that rival high-quality microphone types. Piezoelectric microphones are another option to consider. They are considered low-quality in the audio world, but they do work well in challenging environments such as under water or high pressure and can pick up vibrations very well, so they may provide good performance for what we are trying to detect. One aspect of piezoelectric microphones is that they rely on mechanical coupling to detect audio signals, which may make them less desirable than other options. Another microphone type that should be considered is fiber-optic. Fiber-optic microphones are very high-quality and should easily detect the audio signatures we are interested in, but are also considered expensive when compared to other microphone technologies. All three microphone technologies discussed should be reviewed and considered for use in this system.

To develop the technology, we believe we have a clear plan to build, test, and provide such a TBI detection mechanism. Initially, we would need to gain access to a cadaver lab or coordinate testing on recently deceased bodies to run impact tests on human subjects and record all the audio signals in the brain with sensitive audio equipment. We would need to choose subjects for the testing in three age groups (children, middle age, and elderly test bodies) with varying degrees of TBI history (no TBI history, some TBI history, or extensive TBI history) in each age group. We will want to record the TBI history of each subject before testing begins. We would then need to have athletes or soldiers wear the headgear during play or field exercises respectively. Once an athlete or soldier has a head impact that results in a diagnosed TBI, we will want to further analyze the audio signatures produced at the time of impact. We will want to classify linear impacts that are more consistent with creating the brain bruising, as well as rotational impacts that are more consistent with tissue shearing. Once audio signatures are identified as specific to TBI damage, all information should be reviewed by a medical panel as part of a published medical report to substantiate the findings. Once audio patterns produced by a TBI are known, then we can have microphones manufactured that will only listen on the specific frequency ranges these sounds occur on. In doing so, this will give us the benefit of mechanically removing any other sounds, or audio “noise”, like the sound of helmets crashing together or other sounds generated around the time of the event. This will dramatically improve the overall performance of the system. Another technique we will want to employ to improve the accuracy of the system is to incorporate noise cancellation to eliminate as much signal interference at the time the impact is recorded to further improve the accuracy of the signal analysis. This plan could lead fairly quickly to what seems to be an exceptionally accurate determination of TBI as a wearable solution.

Once the microphone TBI detection mechanism is completed, we can quickly add this technique to our existing biometric headgear design to enable a comprehensive Internet-based wearable TBI detection system. Our existing biometric headgear was implemented in two ways for use. One is a skullcap that can fit under helmets for military or sports activities. The other is a headband to use in sports or physical activities that don't utilize protective headgear such as soccer and baseball. Both incorporate accelerometers to monitor G-force impact in a manner consistent with the most accurate head impact research design currently available. This research accelerometer design is known as Six Degrees of Freedom (6DOF). Both also include a heat sensor to monitor for overheating. In total, the current baseline biometric headgear implementation records 6 axes of measurement to 0.1 GForce precision at a rate of 800 reads per second, and 1 heat sensor sensitive to 0.1 degree Celsius to provide measurements. We have an add-on discrete ear clip that measures blood oxygenation levels and heart rate if desired. However, the biometric headgear control panel was designed to support additional sensors in a plug-in and run fashion, so we can easily use the existing design for this new microphone-based detection device. The reason why we will want to use our existing design is that it already has the wireless technology and control panel finished, and it already has the accelerometer design completed. We also looked at the implementation details of the microphone implementation and realized that we didn't want to send a constant stream of audio recording over wireless networks or have to provide server-side hardware to support such constant streaming of data, both of which would make the service very expensive per person to provide. We instead have decided to utilize the accelerometers to act as a “trigger” to turn on the microphones at say, 30 Gs of shock. We believe that there is a delay of up to milliseconds between when the accelerometers will detect the shock and when the resulting TBI creates any sounds, which will give us plenty of time to have the accelerometers turn on the microphones and start recording. Once we start recording, we will only need to record a few seconds of audio signals to capture any sounds the TBI created. This will give us a low-power solution that will only send small packets of data over wireless networks when impacts of 30 Gs or more occur. Of course, the microphone implementation should be highly accurate if designed properly. However, the accelerometers will act as an additional filter because only small subsets of audio signals will be recorded right after a significant impact. This will allow us to better target analysis for correlation with specific audio signatures and further improve the accuracy of TBI detection. As the system is used in the field, the audio recording equipment will work to further identify sounds associated with TBI that may have not been identified in the initial testing and development of the system. As those acoustical patterns are further correlated to actual injury by susceptibility weighted imaging (SWI), MRI, and/or CT scans or further diagnosis by a physician after the injury has occurred, the system can be matured over time to a high degree of accuracy in detecting the injury during physical activity.

We can use piezoelectric sensors as voltmeters on the surface of the skull to identify how much intracranial pressure is being built up in the head as it is occurring post-injury. This intracranial pressure is what creates subdural hematomas and internal bleeding of the brain, and is what actually causes death in TBI. As the pressure builds inside the skull, the pressure of the brain swelling against the skull should increase the piezoelectric effect on the surface of the skull itself in the region where the subdural hematoma is occurring. This increase in voltage output over time, say several minutes, could easily indicate whether or not subdural hematomas are occurring as well as the rate of increase and current pressure levels inside the skull. This of course would be a complete game changer in TBI care aside from everything else we're doing, and would be incredibly valuable to any medical practitioner to have that kind of information in real-time. It definitely could potentially save lives, and all we need to do to develop that technique is to simply measure piezoelectric effect of the skull during normal activities, as well as know what the piezoelectric voltage output is on the surface of the skull during a subdural hematoma. There is absolutely no doubt in my mind that with current piezoelectric technology we can easily pick up the changes.

In addition to detecting TBI, these techniques can be used to develop technologies like the cap as wraps or worn materials such as a shirt, hat or pants to detect injuries all over the human body, from head to foot. These techniques could also be used to detect diseases and monitor overall conditions such as growth of a tumor or monitor for mini strokes and major strokes, or seizures, or mini heart attacks or major heart attacks, or any other cardiovascular or neurological condition. Progression of disease or conditions can be monitored in a noninvasive way. These same devices could be used to administer treatment options that require voltage, magnetic field, light or other energy waves directed into the body or head to render positive outcomes or accelerate healing of internal and surface tissues.

The wearable sensor packs described in the previous patents filed above have described a means by which sweat can be collected from the skin of a human or animal and analyzed to identify internal physiological conditions. The sweat analyzing sensor could extend the sweat monitoring capabilities to include a flexible or rigid sensor system that can measure metabolites and electrolytes in sweat, calibrate the data based upon skin temperature and sync the results in real time to a network such as the cloud based architectures currently in use. The reason for monitoring heat levels is because the response of glucose and lactate sensors can be greatly influenced by temperature. The sweat sensor monitor could simultaneously and selectively measure multiple sweat analytes for properties and levels. The sweat collection as mentioned in previous filings could be placed on the head or body to collect different kinds of sweat. The sensor array may take measurements from the sensors, amplify the signals, and/or send measurements to a central control pack on the body wirelessly or through wires that run along the body that can then be transmitted wirelessly to a portable device or computer network. The wires that run along the body can do so through wires that are attached to a shirt, pants, or other article of clothing, or through wires sewn into a fabric worn by a human and/or animal that produces sweat, such as a horse. These sweat sensor packs could also measure vital metabolite and electrolyte levels. Small amounts of electrical charge can also be applied to areas of the skin and actually clause sweat to be secreted from the skin that can then be used by the sweat sensor to identify internal illnesses injuries and other biological conditions. Sweat is rich with electrolytes, electrically charged ions of elements like sodium, chlorine, and potassium with concentrations from ones to tens of millimoles per liter. Normally, blood contains 3.5 to 5.2 millimoles of potassium per liter in comparison. Differences in electrolytes levels can indicate dehydration, muscle cramping, and other potentially severe conditions. Although sodium and chloride in sweat themselves don't necessarily provide any correlation to what's happening physiologically in the body, the sodium released through sweat can be useful in other ways. If for instance a sensor was used such as an ion selective membrane and a reference electrode typically made of silver chloride, the sodium release could be used to generate power to run the sensor packs, or charge a rechargeable battery on board the human or animal. Such a sensor could be constructed based on ion selective membranes made for sodium, which will then allow sodium molecules to pass through some sort of filter, such as a polymer coating. Because sodium is a positively charged ion, a voltage of several millivolts can build up. That charge could then be used to trickle charge a rechargeable battery, or be held by a capacitor for use in the sensor pack system at some point in the future. The sensor pack can also measure the ion concentration of sodium and chloride to figure out how much salt is in sweat. Another such sensor that could perform this functionality as paper microfluidics, which are more commonly found in present pregnancy test sticks. Such a sweat sensor could be used to test for cystic fibrosis and other potential illnesses or conditions. The sweat sensors can also measure metabolites such as lactate, creatinine, and glucose. There are additional biomarkers contained in sweat such as small protein cytokines. Cells release cytokines under a number of circumstances including trauma, infection, and cancer. There is a potential that cytokines related to TBI, Parkinson's, Lou Gehrig's disease, Alzheimer's, and other neurological disorders might be detectable in sweat from the head and/or body. The sweat released by your head is primarily being released by the sweat glands through the hair follicles. There are three types of sweat glands on the human body and in the bodies of some animals such as horses. Holocrine glands release the whole cell contents to the skin by breaking the entire cell down and releasing the inner fluids called sebum. Apocrine glands can release proteins, lipids, and steroids, and are concentrated in your armpits and private parts of the body. Apocrine glands only appear after puberty and are considered associated with emotions because they are most active during times of stress and pain. Nerocrine glands release the contents of the entire cell through electrocytosis and are the vast majority of lands on the head and/or body. New cream glands also release lysozymes and even antibodies. All of these properties of sweat can be detected and identified in trace amounts to better understand what is going on inside the body of the human and/or other animal. These sweat sensors could also be used to detect various neuropeptides that can give clues to the state of the human and/or other animal's brain. Orexin-A, for instance, can be used to measure overall alertness. Such sensors to detect sweat can also be my manufactured out of nanowires, nanotubes, and graphene electrodes. Researchers have already been successful in building sensors capable of measuring biomarkers present at only a 1/100 picomolar concentration in sweat. Therefore, sweat monitoring utilizing these materials can provide large amounts of physiological information in a noninvasive manner on the human or animal body. The nice thing about monitoring all of these biomarkers through sweat is that these are biomarker tests that can be run continuously as a replacement for blood tests attempting to utilize the same biomarkers to identify illnesses and injuries.

Piezoelectric sensors can be manufactured from a number of crystalline based materials. Materials considering the manufacture of piezoelectric materials may include sled, magnesium, titanium, and niobium oxide. Ceramics can also be considered but they are not as efficient as the crystals produced through PNM-PT application. As with all wearable sensor applications, one of the primary components is power availability. To address this issue we propose an entirely new line of apparel specifically designed to energy harvest the body's voltage outlay, heat outlay, and mechanical outlay as well as potentially solar capture on the surface of the body. As discussed in previous patent filings, the body has a natural piezoelectric effect or streaming potential which gives voltage release from the body naturally in an ambient capacity. Associated voltage levels increase in amount as the human and/or animal performs exercise such as walking, running, jumping, etc. Such materials for an apparel line may contain several specific design elements to harness the voltage outlay for use in trickle charging a rechargeable battery or to directly power sensor packs and/or SOC sensor designs in real-time. Piezoelectric and/or photoelectric sensors can be manufactured as monofilament or multi-filament strands at or under a millimeter in thickness, which can then be sewn into fabrics worn in everyday material such as synthetics, cotton, or other materials suitable for wearing. Additionally such materials could utilize piezoelectric film as flat wafers to be placed over joints on the body that move frequently during exercise such as the elbows, shoulder, ankle and knee regions. Either of these designs could be used independently or in conjunction with each other to maximize electrical production of energy while being worn. Piezoelectric film could be utilized in different thicknesses to improve electrical production. For instance over regions of a larger muscular capacity thicker piezoelectric film could be used and in regions where smaller muscle groups are utilized in her materials could be used to not impede overall movement of the human or animal wearing the apparel. These same piezoelectric materials can also conduct electricity from the body as it is being released through piezoelectric effect, streaming potential, or any internal biological process that produces voltage outlay. In doing so the material creates three energy harvesting mechanisms based on the body's ability to naturally release voltage, mechanical stress on the piezoelectric materials on the body, and solar energy coming in contact with the material. This same piezoelectric material could be utilized to network sensors from different parts of the body together for power management and/or information transfer. The same piezoelectric material could also be utilized by the injury detection mechanism mentioned in previous patent filings to indicate injury all over the body as they occur or indicate change in physiological condition for purposes of monitoring diseases and or other illnesses.

Significant accelerations such as running will produce increased voltage responses all over such piezoelectric apparel that can be collected for further harnessing of energy in the form of electricity. In addition heat is given off from the body and heat differentials can exist that can allow thermodynamic generators to amplify voltage levels or produce voltage levels on their own that can be used to provide power for sensor packs and potentially other devices on the body such as cell phones and wristwatches. Such wearable materials could be constructed in a manner where certain piezoelectric materials could be sewn into apparel for the purpose of harnessing energy from the body and ambient conditions such as heat differential through thermodynamic generators, as well as solar conductivity through the use of photoelectric threads. Photoelectric threads may be produced out of photovoltaic material small enough to be woven into fabrics. Such photovoltaic materials can be fabricated with monocrystalline or multicrystalline silicon, amorphous silicon thin film, copper indium diselenide/copper indium gallium diselenide (CIS/CIGS) thin film, or cadmium telluride (CdTe) thin film. The same wearable material can also have piezoelectric threads sewn into the material that will allow output from the sensor pack back to a region of the body that can be responsible for applying voltage and or heat outlay back into the body to assist in releasing hormones and or other chemicals that might induce emotional response. One such application could be to heat a given region of the body for pain management as well as reduction of inflammation.

Voltage and/or heat outlay from the same mechanism could be used to heal human and/or animal bones and other tissues within the head and/or body. It has been proven that broken bones can heal up to two to three times faster if a voltage is applied to the broken region. Such a system should be allowed to apply voltage for a specified period of time during certain intervals throughout the day to maximize growth rates of the broken bone and hence reduce the recovery time is much as possible. This material could be applied inside a bone cast and used to reduce broken bone healing time from say six weeks to three weeks or better. Another example of this could be that once detection is made of a human and/or animal that certain mental stress levels or physical fatigue levels are increasing, voltage back into the body could allow for certain chemicals to be released such as dopamine in the head to reduce anxiety or manage anger. Another such application could be to increase adrenaline release during sport to improve athletic performance. The same system could be used to cool the body to offer relief from overheating and other physiological conditions that may require cooling of the body.

Since certain threads may be responsible for harnessing energy from the body and other threads may be responsible for imparting voltage or heat back into the body, there may be a need for insulation of the threads that are imparting voltage or heat back into the body to prevent them from interfering with the energy harvesting aspects of the material being worn. This in effect will allow materials to be worn on the body and/or head that will act as a power generator and/or overall physiological monitoring and/or management solution. Such materials could be used in conjunction with other sensors such as sweat analysis sensors or other physiological sensors to identify conditions and create an alternate response mechanism to improve the overall condition.

The sensor packs mentioned in all previous filings, as well as this one, could be implemented as System on a Chip (SOC) designs to micronize the sensor pack setups. SOC designs are where multiple chips are combined into a single chip die. All sensor designs that are made as SOC designs could includes a processor, memory, and or RF transmitter, and one or more sensors on a single chip to dramatically improve power management and reduce the size of the sensor packs, as well as increases in overall efficiency. The SOC designs can also be applied to any of the sensor packs mentioned in the previously referenced patent designs. SOC designed sensor packs can be placed all over the head and/or body for monitoring all aspects of biological functions. These SOC designs, if considered as part of a network all over the head and body of a human or animal, can be wired to transmit sensor data to a central communication pack located somewhere else on the human or other animal, or can transmit information directly to an external computing device such as a tablet, phone, laptop as referenced in the previous patent filings. The conditions that can be monitored by the apparel include muscle fatigue, blood oxygenation, heart rate, lung rate, blood pressure, body heat, and any other neurological or cardiovascular condition mentioned in previous filings.

Sensor packs as described above and in previous patent filings can also be used to monitor physical fitness machines such as weightlifting and cycle machines. Most workout machines involve a belt, cable or chain that is attached to weight or provides some notion of friction. Clamps made of tactile, pressure, and/or light sensors could be placed upon the belt, cable, or chain. The stress levels detected by the tactile, pressure, and or/light sensors could then be used to indicate number of sets, repetitions, distance, and amount of weight or friction used on a particular workout machine. This information could then be transmitted through a sensor pack in any of the manners previously described in the aforementioned patent filings. The same system could then be augmented or some other system using sensors on the body could utilize services from physical fitness and athletic trainers to further interpret information on behalf of a user of said system. This could allow a trainer to interpret the data further on behalf of the individual or animal utilizing the sensor packs and offer guidance based on that data. Such guidance could include adjustment to work out as well as diet and could be provided over the Internet, via phone, or in person. Physical and athletic trainers could also be allowed to capture their observations through speech to text over a computer network or by audio and/or video recordings of their interpretation of the data. Uses of the system could also utilize speech to text, audio, and/or video recordings to communicate with the physical fitness or athletic trainer as well.

### Engineering Notes

Ionic bonding is a kind of chemical bonding that arises from the mutual attraction of oppositely charged ions. Ions of like charge repel each other, and ions of opposite charge attract each other. Therefore, ions do not usually exist on their own, but will bind with ions of opposite charge to form a crystal lattice. The resulting compound is called an ionic compound, and is said to be held together by ionic bonding. In ionic compounds there arise characteristic distances between ion neighbors from which the spatial extension and the ionic radius of individual ions may be derived.

The most common type of ionic bonding is seen in compounds of metals and nonmetals (except noble gases, which rarely form chemical compounds). Metals are characterized by having a small number of electrons in excess of a stable, closed-shell electronic configuration. As such, they have the tendency to lose these extra electrons in order to attain a stable configuration. This property is known as electropositivity. Non-metals, on the other hand, are characterized by having an electron configuration just a few electrons short of a stable configuration. As such, they have the tendency to gain more electrons in order to achieve a stable configuration. This tendency is known as electronegativity. When a highly electropositive metal is combined with a highly electronegative nonmetal, the extra electrons from the metal atoms are transferred to the electron-deficient nonmetal atoms. This reaction produces metal cations and nonmetal anions, which are attracted to each other to form a salt.

The nature of the piezoelectric effect is closely related to the occurrence of electric dipole moments in solids. The latter may either be induced for ions on crystal lattice sites with asymmetric charge surroundings (as in BaTiO3 and PZTs) or may directly be carried by molecular groups (as in cane sugar). The dipole density or polarization (dimensionality [Cm/m3]) may easily be calculated for crystals by summing up the dipole moments per volume of the crystallographic unit cell.[12] As every dipole is a vector, the dipole density P is a vector field. Dipoles near each other tend to be aligned in regions called Weiss domains. The domains are usually randomly oriented, but can be aligned using the process of poling (not the same as magnetic poling), a process by which a strong electric field is applied across the material, usually at elevated temperatures. Not all piezoelectric materials can be poled.[13]

Of decisive importance for the piezoelectric effect is the change of polarization P when applying a mechanical stress. This might either be caused by a re-configuration of the dipole-inducing surrounding or by re-orientation of molecular dipole moments under the influence of the external stress. Piezoelectricity may then manifest in a variation of the polarization strength, its direction or both, with the details depending on 1. the orientation of P within the crystal, 2. crystal symmetry and 3. the applied mechanical stress. The change in P appears as a variation of surface charge density upon the crystal faces, i.e. as a variation of the electric field extending between the faces caused by a change in dipole density in the bulk. For example, a 1 cm3 cube of quartz with 2 kN (500 lbf) of correctly applied force can produce a voltage of 12500 V. Remember this part. It will mean a lot later.

Piezoelectric materials also show the opposite effect, called converse piezoelectric effect, where the application of an electrical field creates mechanical deformation in the crystal.

Dry bone exhibits some piezoelectric properties. Studies of Fukada et al. showed that these are not due to the apatite crystals, which are centrosymmetric, thus non-piezoelectric, but due to collagen. Collagen exhibits the polar uniaxial orientation of molecular dipoles in its structure and can be considered as bioelectret, a sort of dielectric material exhibiting quasipermanent space charge and dipolar charge. Potentials are thought to occur when a number of collagen molecules are stressed in the same way displacing significant numbers of the charge carriers from the inside to the surface of the specimen. Piezoelectricity of single individual collagen fibrils was measured using piezoresponse force microscopy, and it was shown that collagen fibrils behave predominantly as shear piezoelectric materials.[23]

The piezoelectric effect is generally thought to act as a biological force sensor. [24][25] This effect was exploited by research conducted at the University of Pennsylvania in the late 1970s and early 1980s, which established that sustained application of electrical potential could stimulate both resorption and growth (depending on the polarity) of bone in-vivo.[26] Further studies in the 1990s provided the mathematical equation to confirm long bone wave propagation as to that of hexagonal (Class 6) crystals.[27]

Biological materials exhibiting piezoelectric properties include:
Tendon
Silk
Wood due to piezoelectric texture
Enamel
Dentin
DNA
Viral proteins, including those from bacteriophage. One study has found that thin films of M13 bacteriophage can be used to construct a piezoelectric generator sufficient to operate a liquid crystal display.

The piezoelectric sensitivity coefficient of human bone is 0.7%, and the coefficient for quartz crystal is 2.3%. Human bone resonates at roughly 0.304 times what a quartz crystal does. Standard quartz crystals vibrate at 32,768 Hz (2 to the 15th power in cycles per second). Therefore, bone should resonate at roughly 9972.87 Hz. That isn't the frequency of the sound that will be produced from the bone breaking or fracturing, but the sound produced from the natural piezoelectric harmonic properties of the bone itself. There may be other resonations from other structures since all DNA and many other tissues have piezoelectric properties.

100 decibels produces a pressure of 2 pascals. The pascal (Pa) or kilopascal (kPa) as a unit of pressure measurement is widely used throughout the world and has largely replaced the pounds per square inch (psi) unit, except in some countries that still use the Imperial measurement system, including the United States. Geophysicists use the gigapascal (GPa) in measuring or calculating tectonic stresses and pressures within the Earth. Medical elastography measures tissue stiffness non-invasively with ultrasound or magnetic resonance imaging, and often displays the Young's modulus or shear modulus of tissue in kilopascals.

In materials science and engineering, the pascal measures the stiffness, tensile strength and compressive strength of materials. In engineering use, because the pascal represents a very small quantity, the megapascal (MPa) is the preferred unit for these uses. Approximate Young's modulus for common substances.

| Material: | Young's modulus: | |
|---|---|---|
| nylon 6 | 2-4 | GPa |
| hemp fibre | 35 | GPa |
| aluminum | 69 | GPa |
| tooth enamel | 83 | GPa |
| copper | 117 | GPa |
| structural steel | 200 | GPa |
| diamond | 1220 | GPa |

In measurements of sound pressure, or loudness of sound, one Pascal is equal to 94 decibels SPL. The quietest sound a human can hear, known as the threshold of hearing, is 0 dB SPL, or 20 μPa. Linear viscoelastic material parameters of porcine brain tissue and two brain substitute materials for use in mechanical head models (edible bone gelatin and dielectric silicone gel) were determined in small deformation, oscillatory shear experiments. Frequencies to 1000 Hertz could be obtained using the Time/Temperature Superposition principle. Brain tissue material parameters (i.e. dynamic modulus (phase angle) of 500(10°) and 1250 Pa (27°) at 0.1 and 260 Hz respectively) are within the range of data reported in literature. The gelatin behaves much stiffer (modulus on the order of 100 kPa) and does not show viscous behavior. Silicone gel resembles brain tissue at low frequencies but becomes more stiff and more viscous at higher frequencies (dynamic modulus (phase angle) 245 Pa (7°) and 5100 Pa (56°) at 0.1 and 260 Hz respectively). Furthermore, the silicone gel behaves linearly for strains up to at least 10%, whereas brain tissue exhibits non-linear behavior for strains larger than 1%. These are good numbers because they confirm our identifying sounds are going to virtually all in the audible hearing range (above 20 Hz) so we should be able pick up all the signals we want on the first pass if nothing major goes wrong.

We may be able to not only detect the tissues tearing with raw acoustics in the near term, and provide a real-time image map of the brain that would resemble a DTI scan but provide more detail into the actual structural as well as nerve damage in the head after a TBI. Acoustical detection of injury is enough, but this could be an enhancement or used for about a million other medical and health purposes.

I have general ideas of what the electrical output may be from different internal structures, and what degree we may be able to sense voltage output, but it is simply too early to tell. However, I was able to find a fair amount of information related to that because the piezoelectric effect of internal human tissues was first identified when they were developing ultrasound. It turns out that the ultrasonic frequencies were initially hyper exciting internal cells in bone and other tissues and causing internal damage because the cells were actually frying themselves from the voltage output of piezoelectric effect. What I can tell you is that when you consider that the head is made up mostly of bone, and connected by tendons, both of which have piezoelectric properties, and that the brain is suspended in fluid which acts as an amplifier as well, then you have a very rich environment for acoustical resonations as well as piezoelectric effect. That might be why there were three separate distinct pressure frequencies picked up by the South Dakota blast impact tests. There may have been many more frequency channels generated, but the test methodology and purpose of that test sequence really wasn't designed to pick up all the different frequency patterns that were occurring. One interesting point that I found was that the piezoelectric voltage output captured simply by the strain on a human leg bone while standing is 14 millivolts. That is constant voltage output that can be measured/captured. Hence the reason why there have been so many studies and attempts to try to capture naturally occurring electricity from the human body to power things like cell phones and implantable medical devices. As for what occurs during a concussion level impact, at this point I believe it will be cataclysmic in comparison. The human head is a mass that is made up mostly of material that is capable of producing piezoelectric effect, with specific design aspects such as nasal cavities, ear canals, and other substrates that naturally support resonation of vocal patterns and will most definitely support resonation of internal tissues tearing.

I think the tissue damage detection techniques are not only now viable, but should be a natural progression of medical imaging from active systems to passive systems. However since then they have been matured by industry in general to a point where I think this is definitely a viable option. At that time, the only way to generalize shape internally for medical purposes was to create energy waves (light and sound) and then send them through the body. Then the reflected waves would be detected by sensors and used to map out the internal structures for magnetic resonance imaging as well as techniques like ultrasound. That is what I mean by active systems, and was done primarily because the sensors themselves weren't efficient enough to detect energy outlays on their own.

### Injuries and Treatment

Injuries to the brain can be life-threatening. Normally the skull protects the brain from damage through its hard unyieldingness; the skull is one of the least deformable structures found in nature with it needing the force of about 1 ton to reduce the diameter of the skull by 1 cm. In some cases, however, of head injury, there can be raised intracranial pressure through mechanisms such as a subdural hematoma. In these cases the raised intracranial pressure can cause herniation of the brain out of the foramen magnum (“coning”) because there is no space for the brain to expand; this can result in significant brain damage or death unless an urgent operation is performed to relieve the pressure. This is why patients with concussion must be watched extremely carefully.

In other words, we can use a piezoelectric sensor as a voltmeter on the surface of the skull to identify how much intracranial pressure is being built up in the head as it is occurring post-injury. This intracranial pressure is what creates subdural hematomas and internal bleeding of the brain, and is what actually causes death in TBI. As the pressure builds inside the skull, the pressure of the brain swelling against the skull should increase the piezoelectric effect on the surface of the skull itself in the region where the subdural hematoma is occurring. This increase in voltage output over time, say several minutes, could easily indicate whether or not subdural hematomas are occurring as well as the rate of increase and current pressure levels inside the skull. This of course would be a complete game changer in TBI care aside from everything else we're doing, and would be incredibly valuable to any medical practitioner to have that kind of information in real-time. It definitely could potentially save lives, and all we need to do to develop that technique is to simply measure piezoelectric effect of the skull during normal activities, as well as know what the piezoelectric voltage output is on the surface of the skull during a subdural hematoma. In addition, the part of the brain that regulates temperature usually fails during subdural hematoma which means a heat sensor on the outside of the body would also be able to register increase in skin temperature consistent with subdural hematomas as well.

As mentioned in previous patent filings, the aspects of the system to track sub concussive impacts over the course of several practices games seasons or years of athletic or physical activity otherwise can be developed into a scoring system potentially referred to as a subconcussive impact score. The sub concussive impact score can be calculated by considering overall linear and/or acceleration or rotational magnitude of each individual impact in combination with the duration of the impact as well as frequency of each impact to give an overall estimation of the likelihood of TBI damage consistent with repeated subconcussive impacts. This score should be calculated throughout the season and/or period being observed and compared to known rates of impact known to cause TBI damage over the course of a season and/or period being observed. Guidance should be offered based on such comparisons as to how to reduce injury if thresholds exceed what would amount to TBI damage at the end of the season and/or period being observed. If the subconcussive impact score exceeds a rate that would cause damage by the end of the season at any point during the season, advice would be to slow the individual or animal down in activities until the sub concussive impact score is gone below thresholds that might pose risk to their health in regards to TBI.

The formula for calculating linear, rotation, velocity and acceleration from multiple XYZ axis accelerometer readings of equal time intervals can be as follows:
1. Import data from the tri-axial accelerometer that is located at the back of the skull. These data points measure the acceleration in each direction of a three dimensional rectangular coordinate system and form the components of each linear acceleration vector. The x-axis is oriented down to up vertically, the y-axis is oriented left to right on the azimuth plane, and the z-axis is oriented backwards to forward on the azimuth plane. This is an index for the time sequenced order of the data points.
2. Calculate the magnitude of the linear acceleration for each vector. This is done by using the Pythagorean theorem with the vector components.
3. Calculate the average and maximum linear force where is the total number of data points. From a programming perspective, the maximum linear force is determined by creating a sorted array in order of smallest to largest value and taking the last data point.
4. Calculate the direction of each vector. The direction is calculated similarly to that in a spherical coordinate system but with different reference points.
   i. First, we calculate the angle above or below the azimuth plane with a positive angle being above the plane and a negative angle being below the plane where.
   ii. Next, we calculate the angle in the azimuth plane with a positive angle being left of the z-axis and a negative angle being right of the z-axis. With this
   calculation we have to be careful with the signs of the coordinates to make sure we are indeed capturing the correct quadrant of the vector location.

Power management and the lack of efficient mid-range wireless capabilities (over 300 feet) are two of the biggest challenges facing IoT implementations. TerraTrace Sensor Integration Packs provide over 400 hours of use of multiple sensors with a standard coin-cell battery which can easily be replaced when needed, or powered by a rechargeable battery that can run over 250 hours continuously per charge. In addition, the TerraTrace SIP wireless protocol can transmit up to half a mile line-of-sight, and can be extended if needed to one mile. Data is encrypted from the SIPs all the way to Azure using TerraTrace's proprietary wireless protocol and SSL encrypted pipes as needed. Our wireless protocol has a 4-phase commit, which guarantees packet delivery and goes well beyond the stability of platforms built on Wi-Fi, Bluetooth or Zigbee, making it ideal for mission critical applications such as healthcare. In addition to enhanced mid-range wireless capabilities, TerraTrace also provides long-range backhauling using any of the 550 GSM cellular networks available globally or the Internet.

### Current Sensor Capabilities Include:

Magnetic integration
Different transmission capabilities
Sleep modes
Temperature down to 1/10th degree F. in accuracy
G-Forces down to 1/10th degree accuracy (digital)
RFID (integrated for a customer 7 years ago)

For large amounts of collected data, SD cards can be used to store the data to be batch uploaded to avoid data fees or the data can streamed in real-time. Recommended to tether and batch to minimize battery drainage. All of these capabilities are literally sitting on the shelf waiting for a customer to use them.

### Sensor Types

General Monitoring
Temperature
Motion
Humidity
Door & window status
Light
Dust
Pressure
Vibration
Mechanical shock
Combustible Gases
Toxic or organic gases
Indoor pollutants
Automotive ventilation
Cooking vapors
Oxygen

TerraTrace™ Platform Short Range Wireless Sensor Pack Options (TPS-Sensor type): Capable of monitoring ID and sensor readings with battery condition, reporting any changes at a preprogrammed time interval. These sensor packs are able to “send” data (transmitter) to the TerraTrace™ Platform Reader or Hand-held for forwarding to either the Local host, Intranet or Internet database via Azure. All models are available with a non-rechargeable coin cell battery offering 400 hours of continuous use, or with a rechargeable battery offering 250 hours of continuous use in the same form factor. All have a standard transmission range of 2000 feet line on wireless range with a four-phase commit per transmission to guarantee delivery.

TerraTrace™ Platform Sensor Pack—Client can specify sensor type from tested sensor type list (1k minimum order)
Example: Temperature (TPS-T)

### Operating Specifications

Reporting frequency: 5 +minute intervals
Can be preset at factory per clients request-1k minimum order to change intervals
Dimensions: ¾ in×¾ in×1.5 in length w/rounded corners and mounting tabs
(19 mm×19 mm×38 mm)
Optional-no mounting tabs
Magnet: Optional—Neodymium magnet with 7 lbs of holding force.
Battery Life: 5 years minimum
Unique wakeup condition (deep sleep until sensor is ready to be deployed)
Transmission distance: 240 feet (72m) in most liquids, 2000 feet (608 m) in open air
Reports: Unique tamper-proof identification, temperature (core temperature with changes of 0.1 +/− degrees F.), and battery condition
One visual display indicators (green LED)
Locating low power RF signal (ID only) every 10 Seconds up to distance of 10-15 Feet
RF frequency range 433 MHz or 915 MHz

TerraTrace™ Platform Smart Sensor Pack (TPSS-Sensor type): Capable of sending permanent ID and, monitoring Battery condition, three axis motion with up t200 “G force” impact range and one client specified sensor condition. This sensor pack is able to “exchange” data (transceiver) from the TPS Reader or Hand-held for forwarding to either the Local host, Intranet or Internet database via Azure.

### Operating Specification:

Reporting default frequency: 5 + minute intervals
Can be preset at factory per clients request-1k minimum order to change intervals
Interval can be modified in the field or from remote location
Two way commutation from the field (local Reader and/or Hand held) or from remote location (Local host, Intranet/Internet)
Immediate alarm if measurement exceeds predefined window
Alarm measurement can be modified in the field or from remote location
Client option to request acknowledged data received message from sensor
Dimensions: ¾ in×¾ in×1.5 in length w/rounded corners and mounting tabs
Standard Size: (19 mm×19 mm×38 mm)
Optional-no mounting tabs
Various custom sizes can be achieved
Magnet: Optional—Neodymium magnet with 7 lbs of holding force
Battery Life: 5 years minimum
Two visual display indicators (green LED-on/send, Blue-receive data)
Unique wakeup condition (deep sleep until sensor is ready to be deployed)
Transmission Distance: 240 feet (72m) in most liquids, 2000 feet (608 m) in open air

Reports: Unique tamper-proof identification, Battery condition, sensor data, 3-axis motion sensor with “G” force info, Signal strength and a locating low power RF signal (ID only)

For locating within the area: The TPSS Sensor is capable of receiving a “locate” command then start sending a reducing power burst every 10 seconds until a 10 ft (3m) radius exists. The locating packets can be received by either the hand held Mini-Reader or the nearest Reader

RF frequency range 300 MHz t960 MHz

TerraTrace™ Platform Smart Sensor Pack w/SD Card (TPSSD-Sensor type): Capable of sending permanent ID and, monitoring Battery condition, three axis motion with up t200 “G force” impact range, two internal client specified sensor conditions and with the option of adding a plug-in external sensor probe. An internal “SD” memory card of up t16GB allows retention of both the created sensor data and also the information sent from the TPS Reader to store. This sensor pack is able to “exchange” data (transceiver) from the TPS Reader or Hand-held for forwarding to either the Local host, Intranet or Internet database via Azure.

### Operating Specification:

Reporting default frequency: 5+ minute intervals
Can be preset at factory per clients request-1k minimum order to change intervals
Interval can be modified in the field or from remote location
Two way commutation from the field (local Reader and/or Hand held) or from remote location (Local host, Intranet/Internet)
Immediate alarm if measurement exceeds predefined window
Alarm measurement can be modified in the field or from remote location
Sensor data compared to previous reading, if no change, records then allows client the option to forward matching data
Allows client to control transmission data timing
Client option to request acknowledged data received message from sensor
Create tamper-proof permanent records contained in the sensor
Dimensions: ¾ in×¾ in ×2.5 in length w/rounded corners and mounting tabs
(19 mm×19 mm×52 mm)
Optional-no mounting tabs
Magnet: Optional-Neodymium magnet with 11 lbs of holding force.
Battery Life: 5 years minimum
Internal Memory Storage (2 GB to max of microSD card)
Full FAT32 file system (Windows compatible)
Data logging storage for full 5 years
Real time access tall data
Transmission Distance: 240 feet (72m) in most liquids, 2000 feet (608 m) in open air

Reports: Unique tamper-proof identification, Battery condition, data from two custom embedded sensors and optional plug-in external sensor probe (client specified), 3-axis motion sensor with “G” force info, Signal strength, and any other data stored within the device and a locating low power RF signal (ID only).

For locating within the area: The TPSS Sensor is capable of receiving a “locate” command then start sending a reducing power burst every 10 seconds until a 10 ft (3m) radius exists. The locating packets can be received by either the hand held Mini-Reader or the nearest Reader.
Optional infrared transmit capability
Dual visual display indicators (Red & Green LED)
Unique wakeup condition (deep sleep until sensor is ready to be deployed)
External voltage and current measurement capability
Optional interface with external sensors (humidity, magnetic, pressure, etc.)
RF frequency range 300 MHz t960 MHz
Sensor Capabilities: The following sensor types are within tested parameters of the TPSSD
*Temperature (internal-PCB & external probe), *3-axis motion/vibration, *Mechanical shock (“G” force)
Humidity (internal-PCB & external probe), Pressure (barometric, 0 t125 psi-PCB & external probe)
Switched event (external probe: open/close, proximity/hall effect, toxic & combustible gas, solvents, etc.)
Additional sensor types can be added to either PCB or external probe per Clients requirements

TerraTrace™ Platform Sensor Reader/Coordinator (TPSR-Reader, TPSC-Coordinator): TPS Reader collects all data from its surrounding area, compares existing data from the specific sensor, then if no change, creates a data log file. If there are exceptions the system will then forward at the next scheduled reporting cycle to the Coordinator which is linked to the customer-preferred method of final data acquisition. This Reader allows direct sensor contact (OTA) with any of our TerraTrace™ Platform Sensor Packs from anywhere in the world.
Readers: The number needed is based on the logistics of the area to be monitored
Coordinator: One per client based Computer/Web interface

Operating Specifications:
Power: Client specified—
AC Model—Transformer to AC source with 6 volts DC output or
Battery Operated Model—Stand alone or with wind and/or solar charging system
Coordinator only (TPSC)—the above two options plus can be powered by USB port
Dimensions: 4.8 in×4.8 in×1 ⅞ in height (12.2 cm×12.2 cm×4.8 cm)
Reception coverage: 120-foot (36m) radius for liquid sensors and 1000 foot (304 m) for open air
Antenna: Internal, Dipole w/2 foot (0.6m) long cable, Dipole WIP, or Yagi (directional long range)
Reader placement: Recommend 10 t14 feet high (3m-4.3m)
Reports: Customer specified with alerts/changes to requested data modified over the air (OTA)
Each Sensor input is time stamped
Each Sensor input creates a receive signal strength (RSSI)
Internal Temperature sensor
3 Axis motion with “G” force
2 GB SD card memory (upgradeable to max of microSD card)

Multiple Status conditions: Storage (Data logger), Release (Forwards all data in buffer), Pass through (Sends sensor data as received in real time), Compare (Allows same sensor data packets to create a running log w/timestamps of same value), Alert (sends only sensor data outside of preset Hi/Low values) and Change (reset command functions i.e. Hi/Low settings, reset Internal Clock, Report values, etc.)

### System Data Links:

Local host (Wi-Fi, CATS, Zigbee, etc.)
Intranet link directly to clients existing system
Internet (GPS, GSM, GPRS and/or Satellite)
Any combination client deems necessary.
RF frequency range 300 MHz t2.4 GHz

TerraTrace™ Platform Hand-Held Mini-Reader (TPSM/R): A mobile device to receive and/or sent data to any TerraTrace™ Platform Smart Sensor Pack (receive only w/TerraTrace™ Platform Sensor).Uses locating signal of sensors to pinpoint location and/or read/write to onboard memory. The TPSM/R interfaces with existing Pads, Tablets, and Android phones using specially designed interface.

Operating Specifications:

Power:

USB port—powered by standard link

Battery backup for saving data between link up with display device

Dimensions: 2 in×2 in×¾ in height (5 cm×5 cm×2 cm). Reception coverage: 120-foot (36m) radius for liquid sensors and 1000 foot (304 m) for open air. Antenna: Internal and/or Dipole WIP (directional). Status LEDs-Power on, Receive data, Send data. Reports: Customer specified, over the air (OTA), requested data from/to sensor. 2 GB SD card memory (upgradeable to max of microSD card)

System Data Links: Local host (USB port) and/or TPS Reader/Coordinator. Although Archetype works with global sensor manufacturers that provide over 140,000 sensor types, the following capabilities have already been integrated, tested, and are in production:

### General Monitoring:

Temperature
Motion
Humidity
Door/Window Status
Light
Dust
Smoke
Pressure (barometric, 0-150 psi)
Vibration
Mechanical shock

### Combustible Gases

LP-Gas/Propane (500-10000 ppm)
Natural gas/Methane (500-10000 ppm)
General combustible gas (500-10000 ppm)
Hydrogen (50-1000 ppm)

### Toxic Gases

Carbon monoxide (50-1000 ppm)
Ammonia (30-300 ppm)
Hydrogen sulfide (5-100 ppm)

### Organic Solvents

Alcohol, toluene, xylene (50-5000 ppm)
Other volatile organic vapors (special order)
CFCs (HCFCs and HFCs)
R-22, R-113 (100-3000 ppm)
R-21, R-22 (100-3000 ppm)
R-134A, R-22 (100-3000 ppm)
Freon (100-3000 ppm)

### Indoor Pollutants

Carbon dioxide
Air contaminants (<10 ppm)

### Automotive Ventilation

Gasoline exhaust
Gasoline and diesel exhaust

### Cooking Vapors

Volatile vapors from food (alcohol)
Water vapors from food

### Oxygen

0-100%-5 year life, 12 sec t90% response
0-100%-10 year life, 60 sec t90% response

The above described Sensor Device, Router and Gateway designs could be used in and configuration of features and/or sensors in conjunction with any of the Sensor and Sensor Device, Router, and Gateway hardware/software/firmware combination designs mentioned herein as well as in patents referenced in the introduction to this patent filing.

This patent discloses a novel concept for measuring overall fit and performance of safety gear on a human or animal. For purposes of this disclosure, a sensor pack consisting of a processor memory and potentially wireless communication with one or more accelerometers will be considered an accelerometer array. In order to monitor overall fit and performance of safety gear, one accelerometer array can be affixed to the body as a cap, band, adhesive, or other means by which to keep the accelerometer array in contact with the skin of the human or animal during movement or impact. In turn, another accelerometer array can be affixed to the safety gear itself. If during movement or impact the readings from the two accelerometer arrays are within an acceptable range of deviation, the safety gear can be considered to be fitted and/or performing properly. If during movement or impact the readings from the two accelerometer arrays are outside acceptable range of deviation, then the safety gear can be considered to be fitted improperly or failing to meet ideal safety conditions. This could be due to equipment failure or environmental changes which change the performance of the safety gear itself. One example of an environmental change that could impact the safety gear's overall performance would be heat as heat affects the performance of certain shock absorption materials as well as tensile strength of some types of safety gear, primarily plastics. Additional sensors such as pressure, tactile, additional force measuring sensors, etc. can be used in any combination to further detect structural failure of the safety gear and/or change in performance due to some outside condition such as an environmental change.

The system described herein should monitor equipment during the course of physical pursuit on given intervals or at certain points such as when the human or animal experiences impact so that the system can actively monitor for change in fit or overall performance which may include monitoring changes in padding, air-filled bladders, shell, or overall material and/or structural failure. The system should also monitor initial performance of safety gear to ensure proper fit as well as providing an overall performance baseline for each individual piece of safety gear utilized by the human or animal. This baseline can then be used to compare against throughout the season or any timeframe to gauge whether or not the equipment is still fitting the human or animal or is performing within optimal safety guidelines. Any significant deviation from the initial baseline or from any sensor comparison point or points should be considered as equipment failure and/or change in fit due to structural change or environmental conditions.

As an example, in American football athletes wear helmets. One such utilization of the system could be to have an athlete wear a headband or skullcap with an accelerometer array mounted inside that will serve to stay against the skin during movement and impacts, and have the same athlete wear a helmet over said headband or skullcap that has another accelerometer array mounted to it. If the helmet is fitted properly, accelerometer measurements from the helmet should be virtually identical to accelerometer measurements taken from the head been or skullcap during movement or impact from initial use as well as throughout the use of the helmet. The system can then on given intervals or at certain events continue to compare the two measurements taken from the two accelerometer arrays to check for deviation outside of acceptable levels. As an example, this deviation may be 5% or some other measurement representing acceptable level of movement. If the system recognizes there is a deviation outside of an acceptable level of movement between the two accelerometer array readings, the system should in turn be able to send out real-time alerts via text, email, or some other communication protocol, or provide some other indication mechanism on the helmet itself to indicate that the helmet is no longer performing properly. This information should also be tracked by a centralized repository such as a laptop, tablet, or other portable computing device as well as backed up on the cloud or other Internet enabled storage facility for use on the Internet through a website or other means of data access. As far as an indicator on the helmet itself it could be one of light, color, vibration, noise such as a beep, or other identifiable trait that will allow an observer to easily determine that the equipment has not been fitted properly is no longer functioning in an optimal capacity.

These accelerometer arrays can be used in conjunction with heat sensors or any of the previously mentioned sensor types to further correlate how failure occurred or why equipment no longer fits. For instance, during the course of a game equipment can become damaged or change in performance based on heat levels. This could be due to the structural integrity of the safety gear or due to materials used in the manufacture of the safety gear, which may or may not include padding, air-filled bladders, any material that may or may not deform to absorb shock, or any material that is designed to improve overall safety.

This system can be used to measure safety gear fit and/or provide overall safety performance metrics for helmets, shoulder pads, shin guards, additional body padding, boots, shoes, or any additional clothing items designed to improve safety in sport or other physical pursuit by a human or animal. The system may be implemented as a system-on-a-chip design with a centralized power source or with unique power sources for each sensor and/or set of sensors used in comparison. The system may be implemented where each sensor and/or set of sensors used in comparison has its own unique wireless communication capability, or it may be implemented where each sensor and/or set of sensors communicates through electrical wiring on the body and/or head of a human or animal in a manner by which wireless communication is not needed on the human or animal. The same system can also be implemented in a manner where there is a centralized wireless communication control module that may or may not be affixed or attached directly to the power supply (i.e., on the same circuit board). The system can also be implemented in a means by which the electronics are sewn into the fiber of apparel garments such as compression clothing for the skin surface measurements, as well as having additional sensor arrays on the safety gear in the same region to compare against for monitoring overall performance in fit of said safety gear. This may involve wired or wireless communication between sensors, accelerometer arrays, or any other sensor combination mentioned in this and/or previous patent filings.

This system may also act to structurally change the safety gear based on information it collects. This could be applied to any safety gear such that the structural integrity is changed or altered in real-time to improve fit or overall performance of the safety gear. For instance, if a helmet over time loses its fit the system may automatically fill an airfilled bladder to improve the fit of the helmet. The system may also make recommendations to observers such as athletic trainers as to what needs to be modified to improve the current safety gear item's performance or indicate when the safety gear is failing during physical pursuit if it happens on a routine basis, or as a single event. As an example, if the back padding plate of the helmet is failing, the system should identify that and to the extent possible pinpoint what aspect of the equipment may be failing. This in turn will help guide observers such as athletic trainers to improve overall performance and/or fit of the safety gear.

Information collected by the system can be used by a potential retailer online or not to guide individual safety gear decisions based on previous measurements taken by the system. For instance if an athlete has frequent significant impacts during physical activity, the system may recommend certain equipment that is more likely to be able to absorb shock. If on the other hand the athlete does not have frequent significant impacts, gear may be recommended that is lighter in weight so as to not encumber the athlete's overall performance. Materials decisions in the construction of safety gear may also be considered during purchase and recommendations may be made based on previous safety gear performance.

This patent discloses a novel concept for implementing a security scheme in a sensor based network. The system should include a sensor, a network (wired or wireless), redundant storage facilities along the transmission route, an endpoint storage facility (cloud based, Internet, or closed network), and a client interface that may be installed on a laptop/desktop or hosted for Internet access through a web interface. Currently, sensor network, implementations don't involve encryption from the sensors to the gateway devices, and rarely do the gateway devices involve any security either storing data locally in clear text or transmitting it to the storage facility in an insecure capacity. To be considered fully secured and non-tamperable, the data has to be encrypted all the way through the system in a manner that cannot be further altered from the source sensor. Normally the data, even if encrypted along one segment of the transmission path, will be decrypted and exposed in memory in clear text in several phases of the data transmission. However, several mechanisms can be employed to improve or maintain a high degree of security in a sensor based network.

One such mechanism would be to have the sensor be implemented with a processor and memory so that firmware can read the sensor directly as if on the same circuit board as the processor and memory or even in the same System-on-a-Chip (SOC) design. If the firmware can read the sensor data, then it can immediately apply logic and only transmit the data through the network in a fully encrypted manner. This will allow the system to be more efficient on transmission, whether on a wired or wireless network segment, as only relevant sensor data will be transmitted throughout the system. In such a mechanism, each transmission device should implement its' own storage and transmission logic so that data is written to memory in a round-robin approach as to not overwrite an existing data packet with new data until all the rest of the data storage has already been written over. If firmware from a gateway device receives a new data packet, it should already know the length of a valid packet and only write the packet to memory or internal storage if it is of valid size and the contents have been verified by a two or four-phase commit wireless or wired transmission scheme from the sensor pack itself If the firmware works in the following capacity then it should maintain a “cursor” position or remember the end memory segment or storage location on disk and write the new packet in an unaltered state after the last segment recorded. If this logic is the only way to receive and transmit data through the network, then there is a dramatic reduction in the data being altered, modified, or otherwise tampered with. Such gateway devices could also support one-way data flow so there is the notion of a wireless or wired receiver, storage or live memory, and a wireless or wired transmitter per gateway. If this hardware/firmware/software design is maintained this will ensure data flows through the sensor network in a secure and unaltered state. This mechanism will also allow the most redundant data storage possible along the transmission path so that if the transaction fails at any one point, the same scheme can be used to maximize the possibility of data recovery along the transmission path.

Another such mechanism to be used in concert with or separately would be to manage a transaction through multiple pieces of transmission hardware along the transmission path so that the sensor pack starts an encrypted transmission which goes wired or wirelessly to another device, possibly a gateway device, and then a session is maintained on the gateway device while the gateway device transmits the encrypted packet of data to a server environment on the network for storage. Once the data is stored, then the server environment sends a successful response to the gateway device in a synchronous or asynchronous manner, and then the session on the gateway device can then end the transaction and session successfully. If the session isn't responded to in a timely fashion by the server or an unsuccessful transmission is registered back the the gateway device, then the gateway device can invalidate the session and attempt to resend as a new transmission. If in turn the server responds at the same time the gateway device is retrying the packet transmission, then the gateway should ignore the response and continue to send the packet again. The server should in turn use an id in the packets coming in or timestamp to verify if the data packet has already been stored. If this logic is maintained in a thread-safe manner at the software level, the system can guarantee packet delivery without serverside storage duplication in a fully secured manner.

Both mechanisms can be used together or separately, but should both maintain a fully secured packet along the entire transmission path as well as maintain a round-robin in memory and on disk storage pattern within each device along the transmission path. This will dramatically reduce the chances of the data being modified or corrupted in any way along the transmission path while ensuring maximum redundancy and recoverability throughout the sensor based network. The initial sensor or sensor packs can consist of one or more of a single type or multiple types of sensors in use. The same system may have multiple hardware devices between the sensor pack and the primary storage facility, and the round-robin memory storage mechanism as well as the transaction management through devices could be employed throughout the entire transmission path. Data should also be stored in a centralized storage facility that will follow the same scheme in an encrypted or unencrypted manner to ensure data is not corrupted or modified from the sensors in use in any way. This will ensure data integrity throughout the system and also render the data court admissible for any purpose.

For client access along the transmission path or from the Internet, the data can then be read into memory, decrypted, and logic applied to offer a summary or quantified view of the data for use in a variety of applications. Any of these transmission schemes may involve laptops, tablets, smartphones, desktops, or server appliances, or any other computing device that can receive and sent data through a sensor based network.

This patent discloses several novel concepts related to the sensor implementations described in previous filings, as well as additional security schemes that could be incorporated into sensor, Internet enabled, smart phone, and/or mobile device based networks, as well as how to best apply sensor implementations to navigate and manage robotic-based systems.

To further understand the nature of these inventions, it is important to first understand the four phase commit transaction protocol that was described in previous filings. The four phase commit transaction model involves several phases to guarantee message delivery between the sensor and the receiver or server environment. The first phase is where the sensor or sensor integration pack (consisting of a sensor, processor, memory, and/or standalone power source, and two-way transmission radio) sends a packet of data to the receiver (hardware consisting of a radio, processor, memory and/or standalone power source). The data may or may not be encrypted during transport. The packet may consist of a header and/or a body of information, as well as a unique id which may be specific to the packet sent as well as the sensor pack id of the transmitter sending the packet. Once the packet is received, the receiver will read the packet and prepare a response. This packet is then analyzed to measure the length and/or the contents of the packet transmitted. A checksum may then be generated that represents the amount and/or contents of the data received. The checksum along with potentially other identifiable information of the initial transmission is then sent back to the sensor pack as the second phase of the four phase commit. Then the sensor pack reads the response, parses out the information which may include a unique id and/or the checksum data to verify the amount and/or contents of the data transmission. Then, the sensor pack may compare the checksum to the data initially sent as part of the transaction. The sensor pack may compare any data points send by the receiver to determine whether or not the packet was read in its' entirety, or whether additional information needs to be sent as part of the same transaction to continue delivering data associated with the initial packet. The latter portion of the decision-making process by the sensor pack may be to determine if the transaction requires multiple packets to be sent to successfully complete the transaction for the entire four phase commit process, or whether or not the initial transmission was successful and should be completed. If additional data needs to be sent as part of the same transaction, then additional information will be sent from the sensor pack to the receiver as part of the process in the same manner as described in the first phase of the four phase transmission sequence. At this point in the four phase commit transaction, if the sensor pack determines that it has sent the last packet of data, or if the initial packet of data was the entire payload for the transmission, then the transmission for the entire transaction will be analyzed for success of failure. If deemed successful, then the sensor pack will send a final confirmation that the transaction was successfully executed as part of the four phase commit protocol and will clear the transaction from its' sending queue.

This may also require that the sensor pack store the transaction in memory locally for retrieval later if needed, possibly in the round robin mechanism that was described in previous filings. If any aspect of the response from the receiver of the transmission is deemed a failure by the sensor pack and/or receiver, then the sensor pack will send a failure response back to the receiver as the final step in the four phase commit to have the receiver reverse out the commit of such data to storage and allow the entire process to restart from the sensor pack. If failure is detected by the receiver, it should send a failure response back to the sensor pack and clear the transaction so the sensor pack can begin the transaction again when appropriate. This will ensure complete data integrity across networks where a single sensor pack is communicating to a single receiver, as well as in cases where there are several sensor packs communicating with several receivers locally all the way up to one or more server environments where data is finally stored for the transaction. In an environment where several receivers are in range of a sensor pack, then the sensor pack should only accept one receiver response, and only communicate with that receiver until the transaction is completed. This mechanism applies if only one data payload is involved as well as if multiple data packet transmissions are needed to complete the transaction. The server environment may be part of a distributed network or a centralized data storage facility. All phases of the communication can be encrypted on a transaction level using the same encryption scheme, or variants of encryption can be used during the process per transmission to further increase security. One-way modulation of the encryption can be applied is to vary the encryption scheme based on information collected during the four phase commit process. In other words, the checksum values could be used to choose another encryption scheme, or the id of the sensor pack or originator of the packet transmission can be used to further randomize the encryption formula or seed data for hash algorithms during processing of subsequent phases of the transmission. The preferred mechanism for encryption is AES 128 or AES 256 encryption. Another aspect of this protocol may be that it doesn't have to initiate a handshake transmission to start the transaction. By eliminating this handshake phase on each transmission, the radio protocol becomes more efficient on power management as well as increases performance over other radio protocols that require a handshake to initiate data transmission.

The same four phase commit transmission protocol described above could be used in an Internet Protocol enabled network, or other closed computing network where one or more computing devices may communicate with one or more computing devices and data has to be delivered in a guaranteed way that cannot be tampered with. To better understand the uniqueness of this protocol, one must understand that Internet Protocol is currently a two-phase commit process. In other words, one computing device such as a server sends data to another computing device such as a client (in server/client networks), and the second computing device simply sends back a basic response, sometimes referred to as an “ACK”, to let the initial computer know that it can send more data. This transaction model is only two phases and does nothing to secure data or guarantee transmission of each individual packet exactly down to the bit level. The four-phase commit protocol does precisely that and ensures that every packet on the network was not only sent in its' entirety, but can verify the sender's identity to a much more stringent level, thereby making it an ideal model for data security on a computer network.

The next disclosure is to enhance the security aspects of a four-phase commit model, or possibly a two phase commit model using similar security techniques. If during either transaction model, the receiver determines that the sender is not an authorized sender, or the data has been deemed to be tampered with or injected from an unauthorized source, then the receiver (server or other computing device capable of processing data) can simply block traffic from the sender. However, other more active approaches can be used to stop unwanted data from being accepted by the receiver. One such mechanism could be an inverse of the Ransomware attack model in computer networks, whereby the receiver can initiate an attack back on the sender computing device. To better explain, one must know what a Ransomware attack is. Ransomware is where software is installed on a host computing device that will when triggered will encrypt some or all of the contents of the host machine and hold the data “ransom” while anyone trying to access the data will have to pay someone or entity money or take other actions before the person or system performing the Ransomware attack will provide a key that will decrypt the data being held ransom. This could also take the form of providing some other information that will allow the user to access the encrypted data upon compliance. If a similar approach is deployed in this security model, the receiver of the network request or transmission could then send a request or software program back to the sender to have the computing device that initiated the transmission encrypted in part or in full so that the receiver has ended the attack from the sending computing device. This mechanism could then allow the sender to verify that they weren't attempting to compromise the receiving computer device or network and in turn be provided information or have a request sent out from the receiver device or network to allow the sender access to their computing device immediately or at some point in the future. This in effect could allow a receiving computer device or network to stop unwanted requests to it in a proactive manner that wouldn't permanently disable or destroy the sending computing device. This could also happen at the protocol level so that upon initial transmission from the sender, the receiver could verify if the packet is valid and from a valid source and then decide to receive the packet for further processing, or if the packet is invalid and/or from an invalid source initiate the reverse Ramsomware-like protection attack on the sending computer device to stop it from continuing to send invalid data to the receiver computing device or network. The security model could take other forms of active denial against the sending computing device or network to stop any unwanted transmissions from being received.

Another computer security model involves analyzing individual software requests on Android devices specifically. The Android operating system is built on a Linux kernel, but inherently has a communication protocol intended to support inter-service communication. These inter-service communication features all involve a mechanism called Intents and/or Notifications. Each has an associated Manager service which runs on the Android operating system as System level services. Most previous security models on Android involve installation of antivirus, malware, or firewall software to prevent access from unwanted users. However, antivirus and malware programs only search files for known virus and malware signatures. In other words, they simply scan files and memory looking for certain byte patterns that can indicate a virus or malware program is either installed or being executed. If a virus or malware is not already identified by a major outbreak amongst tens of thousands of users and a virus signature pattern isn't built into the antivirus or malware protection program, there is a strong chance the virus or malware will execute and run uninterrupted by such protection programs. Firewalls on the other hand only block traffic based on known protocols and can do little to stop a program that has been installed that can take “Root” access on the Android device, or change other system configurations to expose data and services on the device to unwanted sources. The additional risk of Android is that Intents and Notifications can be fired at any time from a “trusted” software program that has been compromised on any download site and can then make requests on the Android operating system through the Intent and Notification services at will without any disruption to change the device's configuration and potentially “Root” the device or change system programs to allow access from an unwanted source. This is the primary inherent danger and lack of security in today's Android configurations. The invention disclosed here is a software or firmware program that will actively scan the Intents and Notifications for potential threats and allow or deny each Intent or Notification request as needed to protect the computing device. One way to eliminate such threats ongoing in the Android operating system would be to install a trusted software program that would upon installation replace the Intent and Notification managers build into Android with custom Intent and Notification managers that will first inspect the Intents and Notifications in realtime for potentially harmful requests. Then, the custom managers could prompt the user to allow or deny the Intent or Notification from being passed to other programs, or apply heuristics to determine if the Intent or Notification is harmful and if so, block it from being broadcast throughout the entire application tier, which is what happens currently. This same Android security software could decide based on user input and/or heuristics which programs actually receive the Intent or Notification so that only programs that are supposed to handle a specific Intent or Notification do so. The current Android Intent and Notification model will broadcast messages to any program registered to receive such events whether that program was the intended recipient or not. For instance, any application registered to receive Storage Intents would by default receive such Intents and Notifications sent out by the default Intent and Notification Managers. If a malicious program wanted to store data but didn't have Storage permissions, it could simply send a request to have a certain payload stored by another System level service that did. This is inherently unsafe as Intents and Notifications can both carry payloads with the request, and this security software could prevent such Intents and Notifications from being propagated from Android software that doesn't have permissions to Android software programs that do. This security software piece could track trusted programs and build up enough logic over time to know what Intents and Notifications are valid requests and which are outside of the norm and either allow or deny automatically, or notify the user of the device and have them explicitly allow or deny the Intent or Notification request. This software application would be able to stop not only known thwarts and hacks, but also be able to stop unknown thwarts, hacks and attacks on Android operating systems.

This same Android security software should either recommend to the user or automatically download and install additional software products such as an antivirus, malware and firewall program. Such antivirus could be Kapersky Mobile Internet Security, Lookout, AVG, CM, or any other major antivirus program in use. Such malware program could be Malwarebytes or any other mobile Internet security suite that does antivirus and additional malware scanning. Such firewall programs can be any mobile Internet Security Suite that offers a firewall, or a dedicated firewall application like NoRoot. This security software should configure any such third party software to not send any user information to the companies providing their software, and NoRoot should not only be configured to only allow trusted programs to access the Internet over the mobile data connection or WiFI, but also only allow those programs to communicate via individual filters per program that will only allow them to run properly and check for updates, but block with filters any requests these third party programs may make to Doubleclick, Amazon, or Google to further track user behavior and device usage. This same program should also eliminate existing threats and vulnerabilities like turn off automatic download of MMS messages and send texts to multiple parties as MMS in all installed text messaging programs, as these are features turned on by default and responsible for attacks to mobile devices such as “Stagefright”. This program should also by default turn on power saving and/or ultra-power saving modes when no application needs to access the Internet as it inherently locks all background processes and will in effect serve as a kill switch on data flow accessing the Internet if NoRoot is installed correctly, or use the feature in power saving and ultra-power saving mode to do so itself when needed. The same security software could also install carrier specific security software on specific carrier networks, like enable and properly configure the “Support and Protection Application” on Verizon for Verizon customers. This security software could also lock/unlock or turn on/off Bluetooth and WiFi at the hardware level as needed through Linux commands to support further security on an Android device. This security software could also monitor for Intents and Notifications that may try to make any System level changes to Bluetooth, Wifi, and mobile data connections during use for further protection.

Other aspects of this security software is that it could schedule a factory reset of the device, possibly from safe mode, so that the device can be set back to the original factory ROM before installing itself and other software programs mentioned above. The security software can also check with the manufacturer online once installed to check the ROM on the device and see if all the files are part of the original factory ROM. If a change from the system files of the original or factory updated ROM, then the security software could invoke a factory reset from safe mode to clean the device entirely and then reinstall itself. The software could also perform a “Root” check to see if the device has been “Rooted” at some point and if so, trigger to reset to factory ROM and continue installation of itself and additional security software. This could be done from software on the device or software that gets read from a USB port on a memory stick or other device to reinstall all software needed as part of this installation. The software could also install a program to protect and encrypt phone calls and text messages for further protection. One such program that could provide such services is Signal from Open Whisper or other SIP or VPN based secure calling. The security software could include all related software such as firewall, antivirus, malware detector, memory scanner such as TDSSKiller, as well as Signal or other call and text security software as part of the initial install so no additional programs will need to be downloaded from the Internet to provide a full security suite. This could be put on a USB memory stick for easier installation and security. The USB memory stick could initiate the check for factory ROM and/or a “Rooted” device, and if detected, start the factory reset from safe mode. Once completed, the memory stick or external device could then via the software start installation of the security software along with additional software programs to fully “lock down” the device.

Another aspect of this security software could be to bundle in and manage payment applications such as Samsung, Google and Amazon Pay systems. These payment systems are inherently insecure on their own and need this level of advanced security to be able to make payments from a portable device in a secure manner. With this security software in place, payments can be made safely from the security of this software suite. A payment system can also be used on top of this security software to enhance the security of any mobile payment system.

Another disclosure is the integration with robotic implementations. The world of robotics has two basic aspects; one being the mechanical components and the other being the artificial intelligence (AI) or the “brain” of the robot. The mechanical components have been matured over the past 50 years to reach a high degree of form and functionality. However, the AI component has seen little advancement. Considering the robotics industry is rapidly approaching, the AI side needs to be dramatically improved or reimagined in other ways. The AI components can drive a small portion of the functionality to an acceptable degree as many robotic implementations will require little decision-making capacity. However, endeavors that require a lot of decision making ability or are creative in nature will require mechanisms to drive them that are outside of the scope of AI. One such mechanism to guide functionality in realtime or in a historical manner would be to have a person wear a suit full of sensors as described in previous filings that would measure the user's overall movement patterns. These patterns could then be sent to a robot to guide it's movements or behavior. One such example would be a robot that would have tracks or wheels to move about and then have two arms that would mimic human arms in movement. The person's movement could then be used to move or reposition the robot in a remote location, and the person's arms could move in a manner that the person wants the robotic arms to move in real-time. Think of gardening where an elderly person may want to garden but can't handle the heat or is otherwise restricted in motion. The person could wear a shirt with accelerometers on the wrists, elbows, and/or shoulders to navigate the arms on the robot in a similar manner. This could allow the gardener to continue gardening while the robot does all the work in the yard. One aspect of this is that it could be done in real-time or movements could be recorded in advance so that they can be played back at a later date to have the robot perform the same exercise repeatedly or at a more desirable time. One other aspect of this is that there will need to be some sort of eyesight of vision mechanism incorporated so the person can see what the robot is doing from the robot's perspective in a manner similarly oriented to the person wearing the navigation suit, clothing or apparatus. One ideal system for this remote vision and spatial awareness could be the Microsoft HOLO or the Samsung/Oculus Rift, or integrated components of both. If the HOLO is used, then the person can have the garden superimposed into their den or immediate vicinity so that they can interact with the robot in a manner relative to the robot's surroundings. The image seen in the HOLO would then be a projection of the robot's surroundings into the person's surroundings. If the Samsung/Oculus Rift is used, then the Rift would need to project the robot's surroundings into the person's field of view in the goggles in a spatially accurate manner so that the goggles are projecting what the robot sees onto the eyes of the person using the system. Any “augmented reality” projection system could serve this purpose.

Another variant of this system could be for contact sports. For instance, maybe the next generation of the NFL is one where robots resembling football players are placed on a football field, and the athletes wear a full body implementation of previous suits mentioned equipped with a myriad of sensors including accelerometers, heat sensors, gyroscopes, and other motion or biofeedback sensors can measure the athlete's performance and make the robot perform the same action. The athletes could potentially utilize the “augmented reality” projection devices mentioned above to see the other athletes relative to where the robots are on the field, in effect being able to directly simulate their own normal movements and performance in the robots themselves. It would allow the robots to play the contact sport without having to worry about the contact portion of the sport. It could also deliver potentially enhanced performance relative to the athletes themselves without them having to worry about much of the injuries that occur in contact sports.

Another potential implementation could be in construction where robots could be trained by people skilled in all manners of construction tasks so that the robots can act in realtime to hammer nails, lay roofing, or run wires, or the robots can be trained in advance to mimic the motion of the artisan or craftsman to perform such tasks in the future or repeatedly. This could also be applied to earth moving equipment whereby the equipment could have two large arms that remove or redistribute rocks and soil. The person could then just move their arm across an embankment and remove a lot of soil or rock from the embankment. Such a system could also have a creative mode where the landscaper or construction worker performs such tasks and the “augmented reality” system shows what the environment would look like after the robot performs the action. This could allow a landscaper to landscape an entire yard in advance and then have the robot perform the work as part of a playback feature once the landscaper is happy with the results. This could also work in construction where the builder could potentially build a spare room and have the robot build if after the builder is happy with the outcome.

Yet another implementation of such a system could be to perform surgery or other medical related exercises remotely. A robot could potentially perform a surgical task anywhere in the world being driven by a doctor who specializes in such a procedure as is needed by the patient in a remote location. This system could be coupled with an online or at home telehealth system as described in previous patent filings referenced at the beginning of this document for further benefits to the patient in a remote or at home setting.

All these mechanisms use the accelerometer, gyroscope or other biosensor readings from the person to create the artificial intelligence for the robot or robots being used in the system. This same mechanism could be used in any creative environment or in an environment where the behavior/actions are repetitive in nature and can more easily be “learned” by user hand and arm movement as opposed to other options.

This patent discloses several novel concepts related to computer security implementations on social media network design as well as overall computer security measures described in previous filings. For securing social media networks, one must consider current insecure network designs such as the Android, Gmail, Facebook and overall Google website architecture. Facebook is inherently insecure due to several aspects including password recovery mechanisms, web spoofing of Facebook pages, the entire friend/unfriend mechanism, and the inherent attachment to single-sign-on services like Google profiles. There are additional inherent weaknesses to data management such as the attachment of Android devices to a Gmail account to access Google Play Store for application download, as well as the fact that many applications downloadable to Android based devices contain Analytics services that send out device and user specific information that can be used to break security models currently in use. There are similar weaknesses in the Apple ICloud environment that can also be addressed with the security models described herein. For purposes of this disclosure, we will refer to the new secure social media network design model as a service or website called Facelift.

To begin with, we should first address migrating Facebook users to the new Facelift network and website. In order to do so, such a secure social media network design should include a feature that will allow a user to set up a new account on Facelift and provide unique username/login credentials for the new account. In addition, the new social media site should require a two-step verification model whereby users have to enter in another email address and or phone number that can be contacted for each login to the system for that user and account. The reason for requiring this feature for the social media side is that it will dramatically improve overall security by requiring a user to have access to not only their own username/password for the account, but it will also require access to a telephone the user has access to (hopefully exclusive) or email account to which they can respond from to verify their identity. For additional security, they can have three-step secure login enabled where an Internet link will be sent via email to the email address of the user or via text to the mobile device of the user which will, upon clicking the Internet link, will open a secure channel to Facelift and then require the user to again provide their username and password as part of the secure channel to provide a third step to the verification process. This will prevent spoofing and other attacks that hackers may employ to access an account they are unauthorized to access. Username and password combinations should by default never be stored on the local computing device such as in a browser or a password vault as that may provide unwanted access to login credentials. Once the user is securely identified and logged in, they can then provide their initial Facebook username and login credentials whereby the secure social media website will then log into the Facebook page and proceed to copy out all relative content the user wishes to keep in their new secure social media website. For instance, if the Facebook user just wants to copy out postings they and their friends have done as well as photos and friend/unfriend selections, then the new secure social media website migration tool will allow just that information. The user will also be allowed to add/remove people that they may not want to unfriend from their Facebook page but no longer want the someone or a group of people to get their postings in the future. This may serve as a more elegant way of unfriending the users without having to tell them for fear of online hate retaliation of some sort. This migration should also allow for individual exclusion of photos and postings if the user wants to “clean” their social media page up during the process by removing unwanted content. The migration tool should also look up current Facelift users and see if the user wants to attach their new Facelift page to a current Facelift customer, whether they are in the user's Facebook profile or not. This will allow for quickly building a Facelift only user base around a user's contacts. Any person migrating to Facelift has the option to send out invites to some or all of their contacts when they migrate to assist in getting their circle of friends moved over to the secure Facelift service.

Facelift should address all the coupling with other services that offer inherent insecurity. For instance, currently both Google Play Store and Apple ICloud are allowing malware and spyware into any application that wants to contain it. In addition, neither service is doing anything to prevent ransomware attacks on computing devices using their services. The new secure social media site should address all such issues to the extent possible. As discussed in the previous patent filing, one should consider implementing the mobile security solution described therein, as it will offer firewalling benefits as well as operating system file monitoring as part of the solution. One important note to make regarding the previously described security suite for mobile devices is that it can be built into the Android, IOS or other operating system as well as provided as a separate download that will hook into the operating system to provide the security measures described therein. Once that is considered, then the malware/spyware/ransomware issues can be addressed on the network side. As part of the network security, the Facelift service should maintain an application store that requires strict coding instruction to each software vendor submitting software to the application store for approval and listing in the store. If a particular application requires Internet access to perform properly (such as an Internet browser application or an antivirus application that needs to occasionally download applications), then the software vendor should provide a list of the IP addresses the software will need to talk to during normal operation. This should be verified by Facelift as part of a testing sequence that for a specified period of time will run the application in a controlled environment and monitored for network access requests to make sure the application is performing as stated in regards to network access. If the application tries to access other IP addresses and ports than the ones that can be verified as belonging to the application vendor, then the application submission will be considered compromised and the application will not be published. The software vendor may also be prohibited from submitting any additional software applications if Facelift deems the vendor is a potentially unwanted or questionable submitter. Once the application is approved for listing in the application store, then the profile of which IP addresses and ports will be automatically submitted to the previously mentioned security suite and the size, encryption signature and application details can then be downloaded into the computing device so that the onboard file monitoring system can verify the files if the application is every downloaded for use by a user of Facelift. The authentication of an application on the device can also be verified by having the vendor sign the application cryptographically with a certificate supplied by a Certificate Authority (CA) or by an internal cryptographic service supplied by Facelift to software vendors to ensure identity and authenticity of the software and it's provider. The firewall on any user devices can also be updated so that it knows which applications can communicate over which IP addresses and ports to run properly. The firewall can then be automatically configured to allow legitimate Internet traffic from the device as well as block any unwanted data traffic that may be attempted by the application at any point during the use of an application downloaded from Facelift. In addition to the firewall allowing and blocking traffic from the application to control it's Internet use, the firewall should also act as a network sniffer that scans each packet of data sent and received from the Internet enabled application and block any traffic that may provide device or user specific information that is deemed to be a potential security risk. Any potential security risk detected by the firewall or any other monitoring component of the device security suite should report such potential breaches automatically to Facelift if the user deems to do so in advance, and any such report should not contain any device or user specific information other than the IP address and other generic identification information as well as any details about the application that may serve to fix or thwart any potential security breach of the system.

The Facelift service will not store any additional information than the user is fully aware of and has requested. By default, the Facelift online service will not store text messages, emails, memos, passwords of any sort (website, WiFi, email server, etc.) in the cloud or any other third party computer network other than credentials specifically needed for the service to run such as account information for user logins and credentials to map a Facebook account to Facelift. The Facelift service will not store any additional information that may be deemed sensitive or private information, such as demographic information about the user or usage tracking details from the user's computing device. The Facelift service will not store actual executable copies of software loaded onto computing devices for retrieval and synchronization between devices in the future, but maintain a list of the executables that will all be downloaded from the main secure application store as needed for restoring a device to a user's profile, or mirroring a user configuration on behalf of the user to another device. This will ensure that if virus or malware infected software ever gets on the client device that it won't be replicated across devices from the cloud backup. The Facelift service should allow the user signing up to potentially use the device software suite to clean up their device by doing a factory reset (possibly from safe mode) and then running the additional security checks, configuration changes, and security application upgrades that all come as part of the mobile device security suite described in detail in the previous patent filing. This will ensure that anyone that has their Facebook and device hacked or infected with malicious software to have a new secure Facelift page as well as a freshly cleaned mobile device ready to download secure and clean software from the Facelift service. It will ensure the fastest cleanup for a standard Facebook user from a hack attack.

The Facelift service can also provide a secure email service as part of the offering whereby the email servers only support SSL and TLS encryption connections for logins to secure user credentials when using email. This will of course encrypt all communication to and from Facelift email servers. There should also be a “kill switch” across all devices whereby when a user realizes they are being hacked, they can login online and shut down their online presence temporarily, as well as shut down their devices connected to the service as well to prevent further compromise. This may involve encrypting the storage on a mobile computing device or some other mechanism to prevent others from accessing sensitive information. The Facelift service should also implement the “reverse ransomware” security protocol mentioned in the previous two patent filings on the firewalls or external access points to the network so that anyone that is identified outside the network, either on the Internet or from the wireless side, gets shut down if they try to hack into the Facelift service or any user accounts, whether online or on the device itself. In other words, the device may be enabled to perform the “reverse ransomware” attack to any other mobile devices if it detects that they may be trying to hack into the device using Facelift from a wireless or wired connection to the Facelift user's device.

All of the described social media security features can be used as part of a new service separate from Facebook, such as the one described as Facelift, or could be implemented by Google and/or Apple to fix many of the primary security issues with Facebook and Google services in conjunction with Android and/or Apple in conjunction with ICloud.

Facelift or existing social media services should leverage security systems such as Signal from Whisper Systems, or some other secure text and call encryption software as part of the mobile security suite to further secure all user communications, and require secure connections for all data flow to and from the devices and the Facelift or other social media service. Facelift or the existing social media services should work with wireless carriers such as AT&T, Verizon, and TMobile to implement a mechanism whereby if a user gets hacked, they system can respond either automatically or by user request to implement a wireless sniffer on behalf of the compromised devices attached to the user account being hacked or compromised to actively identify who is hacking the website or devices in real-time. By “sniffing” the wireless data and voice connections from the devices connected to a user's account, the system can capture all data flow and help identify the attacker and/or implement a “reverse ransomware” or similar attack against the hacker to prevent further compromise of the user's data and personal information or communications.

This patent discloses several novel concepts related to computer security implementations on social media network design as well as overall computer security measures described in previous filings and related to the “Internet of Things” computer architecture. For securing social media networks, one must consider better login schemes. Current login schemes for social networks, and all other computer based Internet enabled systems just require a unique username and password combination to access the system. Such login schemes can be used on any computer or device as long as the username and password is accurate. The new login scheme proposed for a more secure network or computer access would require not only a unique username, but could also use a password that uses a user input password such as from a keyboard or from mouse or screen clicks and combines it via a secure hash algorithm or other joining algorithm that combines the password with the MAC address, IP address, or other information referenced uniquely on the device itself. The password could also be joined to any other information that is specific to the computing device the user owns or could be additional biometric information such as a fingerprint, facial recognition, retinal scan, speech analysis, or other biographical information to generate a number sequence that can then be joined to the password. Such methods for joining the user supplied password with the additional biological or computing device-specific information could be through hash algorithms, XOR, or any ad hoc algorithm that would further obscure the initial password from the user. This same scheme could also not involve user supplied passwords but simply use an initial setup sequence that would involve the user registering their speech pattern, face pattern, fingerprint, retinal scan or other biological information unique to the individual that may or may not be registered under a username which may or may not be an email address to login to the account. Then new signups could compare this information to existing profiles of users to make sure the user has a single account that cannot be compromised. This will ensure identity of the user to other users of the system and vice versa. This scheme would also reduce the likelihood of social hacking for passwords as logins would require the user as well as their specific hardware to be used to login to the system or secure social media network. This will ensure no accounts are logged into through primary current hacking techniques. The username could alternately be just an internal or assigned username that is given or allowed to be changed by the user upon initial unique account signup. This will make the system easier to use and more difficult to hack through current hacking techniques.

In addition to more secure login schemes to be employed in the new secure social media services, there are additional security measures that should be considered. Other additional improvements were mentioned in the previous filings this year, but will be expanded upon to avoid any confusion.

Some improvements are on the mobile security suite, which include several design enhancements. One such feature is the need to replace any short range communications managers such as the Bluetooth Manager and the NFC communications stack with software that will expose such data transfer to the user so they will know such services are being used, by both foreground and background processes. Current Android implementations will allow the device to connect via the Near Field Communications and Bluetooth Managers in a manner whereby the user simply doesn't even know the device is being connected to. Each connection should be automatically terminated if hacking is suspected, and connections using such services should never happen without the user either knowing about them or even being able to allow or disable such connections per attempt, whichever the user prefers. The user should be in complete control of all such communications at all times. In addition, no files should be allowed to be changed unless the user allows by explicit permission either per request or for request type. The software should also be able to prevent any unwanted attempts to “root” the device at any time based on user preference. One additional measure would be to put all system level files in a read-only storage facility on the device such as a write once computer chip, which will ensure that system level files are never compromised or replaced. This same technique could be used by any computing devices such as desktops, laptops, tablets, or any mobile device to ensure system level files are never tampered with on any computing device.

The Internet of Things is a new style of architecture that will connect every product electronically, and most likely wirelessly, to the Internet. Many device manufacturers are currently building in sensors with radio communication that would allow the product's internal status, usage patterns, or other information regarding operation or process to be sent out via radio signal to hardware devices that can listen to their communication and transmit that communication to the Internet, or have a computer hardware or software system on the Internet that could send information to the product and have it respond in kind. This two-way communication between the product and the Internet is now being referred to as the “Internet of Things” computing architecture. The means by which the products will primarily communicate to the Internet will be through hardware devices known as gateways and/or routers that can send and/or receive the signals from the product. These communications may or may not occur over a cable and/or “short range” and/or “mid range” communications such as WiFi, RFID, Zigbee, Bluetooth, Openware (our own four-phase commit protocol described in detail in previously mentioned filings), LoRaWAN (LoRa), Sigfox, cellular, satellite, or any other ad-hoc wireless communications protocol in any combination, and then send them to the Internet via a dedicated or intermittent Internet connection (which may be in turn wireline or wireless, or any other combination mentioned above). The routers or gateway devices that are currently available are devices such as Rasberry PI, Android devices, etc. Although these devices will work in limited capacity, they are in no way equipped to handle multiple short range transmission protocols “out of the box” and are not capable of connecting all products in a local environment to a single gateway or router device. One new router/gateway device design could be a hardware design that can scan a household, manufacturing facility, or other local region for wireless transmissions such as radio signals. Then decode the signal into raw data that the gateway/router device can understand. These wireless transmissions can be WiFi, RFID, Zigbee, Bluetooth, Openware, LoRaWAN (LoRa), Sigfox, cellular, satellite, or any other form of “short range”, “mid range”, or “long range” radio signal protocol or airborne signal otherwise that may be used for IoT systems. Once the signal is decoded, the router can then scan for such signals on a scheduled interval or permanently as to act as a receiver for the signal detected. This will in turn allow the gateway/router to undergo an initial setup routine to decode all signals coming from any radio frequency enabled devices or products and then normalize them into a language the gateway/router can understand. The gateway/router can then transmit the normalized information from one or more devices or products to the Internet such as a cloud environment like Microsoft's Azure platform, Amazon's AWS (Web Services) platform, or some other computer network residing on the Internet or computer communications network. The data can then possibly be stored and/or used to drive business processes such as rules engines or business workflows in real time or at some point in the future. Such processes could include emailing parties when certain information indicates they be notified. As an example, if a refrigerator warms to a certain level that would indicate the cooling system is failing, then a service technician can be notified via text message, email, or other form of communication. The service technician can then be instructed to come out for a service check and possibly fix the refrigerator before all the food spoils. The gateway/router can also support devices being connected by cable directly as opposed to wirelessly for communications.

The scanning mechanism described above can be designed in the following ways. The gateway/router can first scan for a specified period to see which products are transmitting information and record which frequencies, baud rates, and/or additional product information can be picked up through real time detection and/or decryption and/or decoding of individual packets of wireless transmission data. All aspects of the different types of communication received from the product(s) in the local environment by the gateway/router should be recorded. The protocol format(s) that are detected can then be looked up via a database on the gateway/router and the product type(s) and wireless transmission type(s) can be recorded as a local wireless profile for the gateway/router to immediately and/or in the future. The information collected by the scan may also be sent to the Internet for decryption or decoding of the transmission type via a product wireless protocol catalog kept in a database on the Internet. The product type(s) and wireless transmission type(s) can then be send back to the gateway/router as a profile so the gateway/router knows how to communicate with each product in the local environment. This information can be stored and/or used for immediate and/or future use. Once the local “short range” or “mid range” network protocol(s) are deciphered and/or decoded and the gateway/router knows how to send and receive data transmissions to and from the product(s), then the gateway/router can then poll the different frequencies and baud rates to receive any transmissions from the products on a scheduled or one-time interval. The gateway/router may implement one or more antennas to perform the sending and receiving of transmissions to different products, if more than one product is sending and/or receiving transmissions. If a single antenna is used to communicate with multiple products, then the gateway/device will have to reprogram the antenna and/or computer logic on the gateway/device driving the antenna reception on a programmed time interval or for a single invocation to be able to send and receive on different wireless protocols on scheduled intervals. In other words, the antenna will have to be tunable to receive different frequencies and/or baud rates from potentially different pick parts and possibly additional information if needed to perform having a single antenna send and receive communications from multiple products. One example of this type of single antenna/multiple wireless protocol in use implementation is if there are five products that can transmit sensor information to the gateway/router. The gateway/router will need to cycle through the different protocols/product types profile created in the setup to scan for all product communications in a given interval at a rate that collectively doesn't exceed the maximum amount of time the products will try to resend information. In other words, if all five products will attempt to transmit for 1 minute before cancelling their transmission to the gateway/router, then the gateway/router will scan on each frequency and baud rate for no more than 12 seconds at a time in a single cycle so that the gateway/router can detect any transmission from any product before the product decides to cancel the transmission. Since there are 5 products in the local environment, 12 seconds of scan for communications from each product will result in 1 minute cycles for scanning all products. This will ensure that one gateway/router device always receives communication initiated by a product. If the gateway/router is designed with multiple antennas, each antenna could be utilized in a way to talk to multiple products or a single individual product per antenna. If each product has a dedicated antenna, then the cycling of scanning for an individual product can be eliminated as each antenna can be constantly listening for communications from each individual product. Additional information such as pick part type used by the manufacturer and any encryption-scheme specific information or other information may be needed to determine how to decrypt and/or decode the data from the products or transmit information to the products, both of which should be enabled by such a system. Specific product wireless profiles could be built into the gateway/router by the manufacturer and/or configured in advance of deployment, or pushed to the gateway/router so that the scanning mechanism is not needed and the gateway/router is shipped to the customer already configured to communicate with certain products and/or product types, or the wireless profile configuration can be controlled by an interface on the Internet via a cloud-based web interface or any other computer interface such as a mobile device, tablet, etc.

The gateway/router design should implement several security features that will ensure no firmware or data transmissions are ever tampered with or intercepted in clear text. This will require the data transmissions be encrypted from the sensor pack all the way through the gateway/router to the Internet as well as to the client interface. The firmware should be signed through a code certificate mechanism and written to read only data storage on all sensor packs as well as gateway/router devices to ensure no tampering with the hardware. A unique id should be assigned to each piece of hardware used in the system in advance of deployment so that each piece of equipment can be uniquely identified in the system. Data that is no longer needed should be erased from local memory so that no device can retain information sent to or received by the sensors. There should also be a transaction layer that begins at the sensor pack and/or Internet, whoever the originator of the transmission is, that will maintain integrity of communication all the way through the use of the system. This could be implemented as a two phase commit, as current Internet Protocol is designed, or it can be implemented as a four phase commit as described in previously filed patents referenced in the introduction of this patent filing. The gateway/router devices can be implemented in a chain of “grid enabled” devices so that the sensor pack may communicate with the Internet through several gateway/router devices en route during transmission.

Transactions could be used to push logic flow from the Internet to the sensor pack so that the sensor pack is capable of performing some of the logic that would normally be executed on the servers. This could lead to a more distributed computing model for systems based on the “Internet of Things” architecture as described herein. Sensor packs could be used to manipulate robots or perform other actions within products for a number of reasons. One could be for product maintenance. Another could be for product execution, such as running a dishwasher at a scheduled time, or turning on and off lights in a warehouse.

An additional gateway/router design could implement a “long range” wireless transmission protocol such as cellular, satellite, or other communications protocol that would not be considered “short range” or “mid range”, in addition to previously mentioned designs in this and previous filings referenced above. This would be done to wirelessly backhaul data transmissions to the Internet or have the Internet enabled system send transmissions to the gateway/router via a wireless “long range” transmission protocol.

The above described gateway/router designs could be used in conjunction with any of the sensor and sensor pack designs mentioned herein as well as in patents referenced in the introduction to this patent filing.

The “Edge” is the “Internet of Things”' (IoT for short) front-line of where technology intersects with business and people, capturing raw data used by the rest of the IoT system. Data is captured by embedding sensors in consumer devices (i.e. fitness trackers, thermostats) appliances or industrial systems (i.e. heating & cooling systems, factory automation) or more specialized applications such as remotely monitoring food temperature and humidity. Such devices can be referred to in this discussion as “Sensor Devices”. Data can then be passed to a “Router” and/or “Gateway” or other “Aggregation Points” that can provide some basic data analytics (parsing raw data) before being sent to the IoT Platform via an Internet connection and beyond. “Routers” can be thought of as local grid or mesh networks whereby implementations such as Bluetooth, Zigbee, WiFi, ANT, OpenWare, LoRa, Sigfox, or other short to mid range wireless transmissions are used to communicate between Sensor Devices and Gateways. Gateways can be thought of as Internet-enabled hardware devices (usually through a wireless WiFi, cellular based such as GSM, CDMA, or other mobile phone carrier network, or landline connection) that communicate either directly to sensors, to sensors through Routers, or a hybrid of both Routers and sensors directly to allow for data to be passed bi-directionally to an Internet platform such as a cloud computing environment or computer network. Also, IoT is not just about capturing data but can also alter the operation of a device with an actuator or other configurable components.

The functionality, shape and size of “Edge” devices are mostly limited by human imagination since most of the technology already exists. For systems including a large number of devices or sensors, gateways and aggregation points serve as the primary connection point with the IoT platform and can collect and prepare data in advance sending the data to the IoT Platform.

“Edge” Key Components

ENVIRONMENT: This is the operating environment of the sensor or device including natural environments (i.e. outside) or man-made (i.e. buildings, machinery or electronic devices). The environment is important when selecting the sensor to ensure it can withstand the ongoing demands of the environment in addition to power management and maintenance considerations of the “Edge” components.

SENSORS: This is where the collection of IoT data begins. In most cases the raw data is analog and is converted to a digital format and sent through a serial bus (i.e. I2C) to a microcontroller or microprocessor for native processing. Typical sampling rates for sensors are 1,000 times per second (1 kilohertz) but can vary widely based on need.

DEVICES OR “THINGS”: Sensors are typically embedded within existing devices, machines or appliances (i.e. wind turbines, vending machines, etc.) or in more complex systems such as oil pipelines, factory floors, etc. To eliminate sensors just sending a copious amount of raw data, some of these devices have basic analytical capabilities built-in which allow for some basic business rules to be applied (i.e. send an alert if the temperature exceeds 120 degrees Fahrenheit), as opposed to just sending a live data stream.

ROUTERS: A router broadcasts a radio signal that is comprised of a combination of letters and numbers transmitted on a regular internal of approximately 1/10^{th} of a second. They can transmit at this rate, but in an “intelligent” hardware scenario (Intelligent Sensors and/or Routers) the transmission will likely be much slower, as in 5-10 second intervals or exception based as needed. The term “Intelligent” simply means that there is application logic via software and/or firmware that may provide some logic or filtering of sensor data so that transmissions are only sent when conditions are met or a change in sensor data warrants an update to the network. Routers provide an added dimension “Edge” computing with the ability to combine the location of either Bluetooth, WiFi, Zigbee, ANT, OpenWare, LoRa, Sigfox, or other short or mid-range wireless communication protocol equipped mobile devices (i.e. customers) and/or wired devices along with other factors such as current environmental and weather conditions. For example, by tracking the location of devices, more context relevant information can be pushed to the device such as special offers and recommendations based current conditions.

AGGREGATION POINT OR GATEWAY: The Gateway or Aggregation Point is the final stop before data leaves the “Edge”. While deploying a gateway is optional, it is essential when creating a scalable IoT system and to limit the amount of unneeded data sent to the IoT platform. Key functions include:
Convert the various data models and transport protocols used in the field, such as Constrained Application Protocol (CoAP), Advanced Message Queuing Protocol (AMQP), HTTP and MQTT, to the protocol(s), data model and API supported by the targeted IoT platform. The HTTP/HTTPS and MQTT are what the gateways will talk to the IoT Platform with. Other local protocols like serial, Zigbee, Bluetooth, WiFi, LoRa, Sigfox, cellular, satellite, and/or OpenWare will normally be used from Router to Gateway.
Data consolidation and analytics (“Edge analytics”) to reduce the amount of data transmitted to the IoT platform so network bandwidth is not overwhelmed with meaningless data. This is especially critical when IoT systems include thousands of sensors in the field.
Real-time decisions that would take too much time if the data was first sent to the IoT Platform for analysis (i.e. emergency shut-down of a device).
Send data from legacy operational technology that may not have the ability to send data to an IoT platform.

### Design Considerations

When thinking about the technology and design for the “Edge” of an IoT solution, business requirements are more important here than the technology itself, so IT personnel will have to work closely with the business to identify and meet the functionality, costs and security requirements. Once these business requirements are clearly understood does the technology selection process begin (i.e. sensors, gateways and design). At the same time, IT brings insights into the potential and capabilities provided by IoT technology which can help drive use case scenarios so collaboration between the business and IT is essential.

After defining the business requirements and the focus has shifted to the technical design of an IoT solution, it is important to first explore any unused IoT infrastructure already built into existing machinery, hardware and software (“Brownfield Opportunity”). There are many types of devices and machines out there already equipped with sensor type technology that is simply waiting to be tapped into. This is the low-hanging fruit that can be quickly leveraged with minimal disruption to the business because the technology has already been adopted while helping accelerate IoT initiatives. The “Greenfield Opportunity” is for IoT opportunities in enterprise environments where no existing IoT infrastructure exists.

There are two major deployment options for “Edge” devices used in an IoT solution:
“Edge” deployment without aggregation
“Edge” deployment with a gateway or aggregation point

No Aggregation: Every device is connected to a network (usually the Internet or other IP based system) enabling the device to send and receive data directly to the IoT Platform. This means each device must have a dedicated network and the ability send and receive data using APIs, the data model and transport protocol required by that IoT platform. The device must also have enough computing power for some analytics and to make real-time decisions such as turning off machine if the temperature passes a specified threshold. Finally, the device must have some sort of user interface for maintenance and ongoing updates.

Non-aggregated designs work best when there are few other devices in the area competing for connectivity. Usually, these devices also have more processing power, memory and an operating system capability so it is easier to add or adjust functionality. However, this added device capability is typically more expensive to implement and non-aggregated designs typically don't scale well with each device requiring individual attention to maintain and secure (unless the IoT Platform provides scalable “Edge” device management). Another potential challenge to consider is if the device does not support the IoT platform's transport protocol. In such cases, additional code will need to be added to each device so support the required APIs, data model and transportation protocol.

Aggregation: This design model includes a gateway or some other type of aggregation point connecting “Edge” devices and the IoT platform.

Aggregation designs are ideal for IoT implementations with a large number of sensors, a fleet of devices and where the devices are fixed and localized deployments. This is especially true for scaling and consolidating device management where multiple endpoints can be managed from a single location. Using gateways and other aggregation points in an IoT design allows for cheaper sensors and devices with less computing power while allowing for integration with legacy operational technology that otherwise may not have been available. Gateways can also consolidate the various protocols, data models and APIs from the various end points to the standards required by the IoT platform while also providing a location before data reaches the IoT platform for additional intelligence and intelligence to reduce the amount of data sent to the platform.

However, aggregated designs also provide another layer of complexity into the design by adding gateways or other aggregation points. This essentially means another link in the chain that needs to be monitored and addressed when there are issues. Additionally, without built-in redundancy into the design, this could also lead to a single point of failure when a gateway device goes down and all of the connected devices have no way of communicating with the IoT platform. As a result, all aggregation points must be designed with built-in redundancy.

### Sensors

IoT sensors are basically a monitoring or measuring device embedded into machine, system or device with an API enabling it to connect and share data with other systems. However, sensors can create copious amounts of data which may have no practical value so analytics or exception based models are applied to reduce it to more of a meaningful dataset before transmission. Data is typically transmitted via an IEEE 802.1 network using an Internet Protocol (IP) to a gateway, router, receiver or aggregation point. The transmission frequency can be real-time streaming, exception-based, time intervals or when polled by another system.

The IoT sensor market is divided into two broad categories. Original Device Manufacturers (ODMs) and Original Equipment Manufacturers (OEMs). ODMs design manufacture the core sensor technology (pressure, temperature, accelerometers, light, chemical, etc.) with over 100,000 types of sensors currently available for IoT solutions. These sensors typically do not include any of the communication or intelligence capabilities needed for IoT solutions so OEMs embed ODM sensors into their IoT devices while adding the communications, analytics and other potential capabilities needed for their specified markets. For example, an OEM who builds a Building Automation IoT application may include various sensor types such as light (IR or visual), temperature, chemical (CO2), Accelerometer and contact.

The ODM marketplace is more consolidates and primarily includes established microelectronics and micro processing incumbents who already have the manufacturing facilities and market share such as ST Microelectronics, IBM, Robert Bosch, Honeywell, Ericsson, ARM Holdings and Digi International. On the flip side, the OEM marketplace more of the Wild West. It includes some of the industry heavyweights but is full of a new generation of startups seeking to capitalize on the IoT market. For example, we have Intel, Fujitsu, Hitachi and Panasonic, in addition to a slew of smaller companies such as Lamer, iWave, Artik, and Inventec. The scope of this paper does not include an in-depth analysis of the ODM and OEM vendor landscape.

The following diagram illustrates the typical layout of an IoT Wireless Sensor Device:

### Current State-Of-The-Union

Some of the major factors driving the growth of the IoT sensor market includes the development of cheaper, smarter and smaller sensors.

While the IoT sensor and device markets are exciting, dynamic and enjoying growth, the coming wave of these small, embedded, low-power, wireless and wearable devices still do not is enjoy ubiquitous and universal access to the Internet. Due to current battery constraints and longevity, these devices tend to rely on low-power communication protocols such as Bluetooth Low Energy (BLE) as opposed to the more connected and more power intensive protocols such as WiFi and cellular (GSM, 3G/4G, etc.). As a result, most of these devices require an application layer gateway capable of translating the communication protocols, APIs and data models to transmit to the Internet and IoT platform.

### Future Trends

While the majority of IoT applications have traditionally been focused on driving operational efficiencies and cost savings, over the next 12 months, Gartner forecasts enhanced customer experience and new customer based revenue applications will take the lead in over the next 12 months.

The future growth of IoT sensors will be driven by the growing demand for smart devices and wearables, the need for real-time computing and applications, supportive government policies and initiatives, the deployment of IPv6 and the role of sensor fusion. Sensor Fusion is essential the current and future demands of IoT. Sensor Fusion combines data from multiple sensors in order to create a single data point for an application processor to formulate context, intent or location information in real-time for mobile, wearable and IoT devices. It is basically a setoff adaptive prediction and filtering algorithms to deliver more reliable results such as compensating for drift and other limitations of individual sensors.

By combining the growth projections of IoT (50 billion connected devices and a $7.1 trillion market) with the market focus on IoT sensor capability and performance, IoT sensors will be one of the most dynamic and explosive sectors in the market. There will continue to be new OEMs selling IoT applications but the market will also begin to consolidate as the market matures, communication standards are adopted and through M&A activity.

### Baseline Requirements When Selecting A Sensor Device:

Security
   Physical
   Firmware
   Data
   Transmission
Power management
   Battery life
   Recharge Ability
Analytical capability
   Sensors or devices producing large amounts of data or IoT systems using a large number of sensors will need to have analytical capability on the “Edge” to filter and select which data will be transmitted to the IoT Platform and beyond. Without “Edge” Analytics, the sheer volume of data can overload networks, create exorbitant communications costs and generate so much data that it becomes very difficult for it meaningful. Additional analytics will happen at the IoT Platform and enterprise applications using the data.
      Exception based reporting . . .
Communication protocols
Wireless API
Device Maintenance Requirements . . .

### Gateways/Routers/Sensor Devices

Information from the “Edge” sensors can be integrated through an Internet enabled platform like an “IoT Platform” such as Microsoft's Azure IoT Platform to perform various services for the customer. Such services could also be integrated into a company's Enterprise Resource Planning or Customer Resource Management software to perform additional services such as scheduling a service call for a failing home appliance or notifying technical support that a particular robotic arm on a manufacturing floor is not operating correctly.

The “Edge” tier of an IoT architecture should consider using an application tier protocol for communicating with servers in an IoT Platform via a standard such as IoTivity from the Open Connectivity Foundation, the AllJoyn Framework from the AllSeen Alliance, or any other IoT specific protocol for application architecture. Such protocols will allow for Sensor Devices to be registered with an IoT Platform and then have them communicate one way or bi-directionally with the IoT Platform during operation. The “Edge” tier can also be integrated into a Device Manager service on the IoT Platform tier so that Sensor Devices, Routers, and/or Gateway Devices can be observed and managed on the IoT architecture. This will provide availability support so that all devices utilized on the “Edge” tier of the IoT architecture can be monitored and serviced as needed.

### Edge as a Service

The entire “Edge” tier of an IoT architecture can be provided as a bundled service to ease the decision-making process in purchasing an “Edge” computing tier. The concept of providing the “Edge” tier as a bundled service is in itself an entirely new concept and business model since the “Edge” tier of an IoT architecture has just been defined as of this year (2016). This new business and technology model will be referred to as “Edge As A Service” or EAAS for short, and is in the process of being registered as a Service Mark with the United States Patent and Trademark Office. The basic concept is to allow a customer who wants to purchase and utilize an IoT “Edge” tier to have them choose the entire “Edge” tier at one time and have it provided to them as a service by which they will may periodic payments for utilization. The decision process for this business model may be as follows in any scenario or order, including one or more steps in the process:
1. The customer defines which sensor capabilities they need.
2. They then are guided toward which Edge Devices they will need to utilize based on the sensor capabilities needed.
3. The customer then chooses the number of such Sensor Devices which may include one or more Sensor Device designs overall.
4. The customer then decides on which Router devices the IoT architecture will need based on capabilities required for mesh networking and/or relay communication to a Gateway device. If no relaying needed for the Sensor Devices to communicate with the Gateways, this option can be skipped.
5. The customer then chooses the Gateway devices will be needed in the overall IoT architecture. This will depend primarily on which communication protocol is used in the overall architecture to access the IoT Platform tier on the network. Some options could include communication protocols such as through a wireless WiFi 802.1*, cellular based such as GSM, CDMA, or other mobile phone carrier network, satellite link such as Orbcomm, GlobalStar, or Iridium, or simply a landline connection such as Ethernet.
6. The customer then chooses casing or embedded versions. Casing may include IP67, IP69, or other environmentally rated enclosures, and/or injection molding, and/or no casing for embedded installation on the target item.
7. The customer then chooses server side options such as which storage requirements for data storage and aggregation, which web services will be required for the operation of the IoT architecture, and/or integration into existing IoT Platform services, ERP, or CRM services for utilization.
8. The customer will then choose the method of payment which may be up-front payment in full or partially (such as hardware up front), periodic payment schedule such as monthly payments, or some other form of payment option provided.
9. The supplier will then determine which components of the system can be used “as-is” and which components need to be developed and schedule development internally or externally to complete the “Edge” tier design and implementation for the customer.
10. Custom development services if needed for firmware/software/hardware development enhancements beyond the core “Edge” components are allocated and executed.
11. Custom development services if needed for server side software/hardware development enhancements beyond the core IoT Platform/ERP/CRM service components are allocated and executed.
12. The entire “Edge” tier is shipped to the customer for installation and enablement.

This decision making and supply process can be performed online with a website, in person, or via other communication medium such as web conference or phone call. Domain specific data models can be crafted to match the sensor outlays used in the “Edge” tier so that any IoTivity, AllJoyn, or other communication protocol can send and receive known data sets specific to an application between the “Edge” and IoT Platform tiers of the architecture. Such domain specific data models should match invocations needed to have the sensors perform properly as well as have the IoT Platform be able to effectively communicate with the Sensor Devices, Routers, and Gateways effectively. Such domain specific data models could be designed as follows:

TABLE 1
Full Datagram

| Data Type | Field Name | Description |
|---|---|---|
| | [FULL] | Designates “full” datagram |
| | [TRUCK] | Denotes beginning of truck data |
| String | Firmware Version | Truckmaster firmware (Major.Minor.Revision) |
| String | Hardware Version | Truckmaster hardware configuration |
| | | (Major.Minor.Revision) |
| Int32 | Serial Number | Electronic serial number of the truckmaster |
| Int8 | TX Reason | Reason for datagram transmission. See table 3 for |
| | | details |
| | [DRIVER] | Driver in the truck |
| Int32 | Driver ID | Number which uniquely identifies the driver |
| | [TK1] | Driver side front tire |
| Int8 | Tire 1 Pressure | Pressure of the tire in PSI |
| Int8 | Tire 1 Temperature | Temperature in ° F. |
| Int8 | Tire 1 Status | Status code. See table 4 for details |
| | [TK2] | Passenger side front tire |
| Int8 | Tire 2 Pressure | Pressure of the tire in PSI |
| Int8 | Tire 2 Temperature | Temperature of tire in ° F. |
| Int8 | Tire 2 Status | Status code. See table 4 for details |
| | . . . | See table 5 for remaining tire position definitions |
| | [TK10] | Passenger side front tire |
| Int8 | Tire 10 Pressure | Pressure of the tire in PSI |
| Int8 | Tire 10 Temperature | Temperature in ° F. |
| Int8 | Tire 10 Status | Status code. See table 4 for details |
| | [TRLR]* | Denotes beginning of trailer data |
| String | Firmware Version | Trailermaster firmware (Major.Minor.Revision) |
| String | Hardware Version | Trailermaster hardware configuration |
| | | (Major.Minor.Revision) |
| Int32 | Serial Number | Electronic serial number of the truckmaster |
| | [BATT] | Denotes beginning of battery data |
| Float | Battery Voltage | Truckmaster battery voltage |
| | [DOOR] | Denotes beginning of door state |
| Boolean | Door Status | (0 = closed, 1 = open) |
| | [TEMP1] | Denotes temperature data near door |
| Int32 | Time Stamp | UTC Time. See |
| | | http://en.wikipedia.org/wiki/Unix_time |
| Float | Trailer Temp 1A | Temperature of internal sensor near back door of |
| | | trailer in ° F. |
| Float | Trailer Temp 1B | Temperature of external sensor near back door of |
| | | trailer in ° F. |
| Int8 | Trailer Temp 1 Status | Status code. See table 6 for details |
| | [TEMP2] | Denotes temperature data in the middle of the |
| | | trailer |
| Int32 | Time Stamp | UTC Time. See |
| | | http://en.wikipedia.org/wiki/Unix_time |
| Float | Trailer Temp 2A | Temperature of internal sensor in the middle of the |
| | | trailer in ° F. |
| Float | Trailer Temp 2B | Temperature of external sensor in the middle of the |
| | | trailer in ° F. |
| Int8 | Trailer Temp 2 Status | Status code. See table 6 for details |
| | [TEMP3] | Denotes temperature data at the front of the trailer |
| Int32 | Time Stamp | UTC Time. See |
| | | http://en.wikipedia.org/wiki/Unix_time |
| Float | Trailer Temp 3A | Temperature of internal sensor at the front of the |
| | | trailer in ° F. |
| Float | Trailer Temp 3B | Temperature internal sensor at the front of the |
| | | trailer in ° F. |
| Int8 | Trailer Temp 3 Status | Status code. See table 6 for details |
| | [TL1] | First axle left side outer tire |
| Int8 | Tire 1 Pressure | Pressure of the tire in PSI |
| Int8 | Tire 1 Temperature | Temperature in ° F. |
| Int8 | Tire 1 Status | Status code. See table 4 for details |
| | [TL2] | First axle left side inner tire |
| Int8 | Tire 2 Pressure | Pressure of the tire in PSI |
| Int8 | Tire 2 Temperature | Temperature in ° F. |
| Int8 | Tire 2 Status | Status code. See table 4 for details |
| | . . . | See table 5 for remaining tire position definitions |
| | [TL8] | First axle left side inner tire |
| Int8 | Tire 8 Pressure | Pressure of the tire in PSI |
| Int8 | Tire 8 Temperature | Temperature in ° F. |
| Int8 | Tire 8 Status | Status code. See table 4 for details |
| | [END] | Denotes end of datagram |

*Trailer section only sent if truck is hooked to a trailer

TABLE 2
Alarm Datagram

| Data Type | Field Name | Description |
|---|---|---|
| | [ALARM] | Designates “alarm” datagram |
| | [TRUCK] | Denotes beginning of truck data |
| Int32 | Serial Number | Electronic serial number of the truckmaster |
| Int8 | TX Reason | Reason for datagram transmission. See table 3 for |
| | | details |
| | [DRIVER] | Driver in the truck |
| Int32 | Driver ID | Number which uniquely identifies the driver |
| | [TK1]* | Driver side front tire |
| Int8 | Tire 1 Pressure | Pressure of the tire in PSI |
| Int8 | Tire 1 Temperature | Temperature in ° F. |
| Int8 | Tire 1 Status | Status code. See table 4 for details |
| | [TK2]* | Passenger side front tire |
| Int8 | Tire 2 Pressure | Pressure of the tire in PSI |
| Int8 | Tire 2 Temperature | Temperature of tire in ° F. |
| Int8 | Tire 2 Status | Status code. See table 4 for details |
| | . . . | See table 5 for remaining tire position definitions |
| | [TK10]* | Passenger side front tire |
| Int8 | Tire 10 Pressure | Pressure of the tire in PSI |
| Int8 | Tire 10 Temperature | Temperature in ° F. |
| Int8 | Tire 10 Status | Status code. See table 4 for details |
| | [TRLR] | Denotes beginning of trailer data |
| Int32 | Serial Number | Electronic serial number of the truckmaster |
| | [BATT] | Denotes beginning of battery data |
| Float | Battery Voltage | Truckmaster battery voltage |
| | [DOOR] | Denotes beginning of door state |
| Boolean | Door Status | (0 = closed, 1 = open) |
| | [TEMP1]* | Denotes temperature data near door |
| Int32 | Time Stamp | UTC Time. See |
| | | http://en.wikipedia.org/wiki/Unix_time |
| Float | Trailer Temp 1A | Temperature of internal sensor near back door of |
| | | trailer in ° F. |
| Float | Trailer Temp 1B | Temperature of external sensor near back door of |
| | | trailer in ° F. |
| Int8 | Trailer Temp 1 Status | Status code. See table 6 for details |
| | [TEMP2]* | Denotes temperature data in the middle of the |
| | | trailer |
| Int32 | Time Stamp | UTC Time. See |
| | | http://en.wikipedia.org/wiki/Unix_time |
| Float | Trailer Temp 2A | Temperature of internal sensor in the middle of the |
| | | trailer in ° F. |
| Float | Trailer Temp 2B | Temperature of external sensor in the middle of the |
| | | trailer in ° F. |
| Int8 | Trailer Temp 2 Status | Status code. See table 6 for details |
| | [TEMP3]* | Denotes temperature data at the front of the trailer |
| Int32 | Time Stamp | UTC Time. See |
| | | http://en.wikipedia.org/wiki/Unix_time |
| Float | Trailer Temp 3A | Temperature of internal sensor at the front of the |
| | | trailer in ° F. |
| Float | Trailer Temp 3B | Temperature internal sensor at the front of the |
| | | trailer in ° F. |
| Int8 | Trailer Temp 3 Status | Status code. See table 6 for details |
| | [TL1]* | First axle left side outer tire |
| Int8 | Tire 1 Pressure | Pressure of the tire in PSI |
| Int8 | Tire 1 Temperature | Temperature in ° F. |
| Int8 | Tire 1 Status | Status code. See table 4 for details |
| | [TL2]* | First axle left side inner tire |
| Int8 | Tire 2 Pressure | Pressure of the tire in PSI |
| Int8 | Tire 2 Temperature | Temperature in ° F. |
| Int8 | Tire 2 Status | Status code. See table 4 for details |
| | . . . | See table 5 for remaining tire position definitions |
| | [TL8]* | First axle left side inner tire |
| Int8 | Tire 8 Pressure | Pressure of the tire in PSI |
| Int8 | Tire 8 Temperature | Temperature in ° F. |
| Int8 | Tire 8 Status | Status code. See table 4 for details |
| | [END] | Denotes end of datagram |

*This section only sent if in alarm

TABLE 4
Tire Status Code

| Code | Description |
|---|---|
| 0 | Normal |
| 1 | Pressure Warning - 25% low |
| 2 | Pressure Warning - 50% low |
| 4 | Temperature Alarm |
| 8 | Battery Low |
| 16 | TBD |
| 32 | TBD |
| 64 | Tire Sensor Lost |
| 128 | Tire Never Found |

TABLE 3
Tx Reason Code

| Code | Description |
|---|---|
| 0 | Unhook Event |
| 1 | Hook Event |
| 2 | Scheduled Summary |
| 4 | New Alarm |
| 8 | Scheduled Alarm |
| 16 | Initial Turn On |
| 32 | Door Open/Close |
| 64 | Unhook Timeout |
| 128 | TBD |

TABLE 5
Tire Positions

| | Description |
|---|---|
| Truck Tire | |
| TR1 | Front Driver Side |
| TR2 | Front Passenger Side |
| TR3 | Driver side first rear axle - Outer |
| TR4 | Driver side first rear axle - Inner |
| TR5 | Passenger side first rear axle - Inner |
| TR6 | Passenger side first rear axle - Outer |
| TR7 | Driver side second rear axle - Outer |
| TR8 | Driver side second rear axle - Inner |
| TR9 | Passenger side second rear axle - Inner |
| TR10 | Passenger side second rear axle - Outer |
| Trailer Tire | |
| TL1 | Driver side first rear axle - Outer |
| TL2 | Driver side first rear axle - Inner |
| TL3 | Passenger side first rear axle - Inner |
| TL4 | Passenger side first rear axle - Outer |
| TL5 | Driver side second rear axle - Outer |
| TL6 | Driver side second rear axle - Inner |
| TL7 | Passenger side second rear axle - Inner |
| TL8 | Passenger side second rear axle - Outer |

TABLE 6
Temperature Status Code

| Code | Description |
|---|---|
| 0 | Normal |
| 1 | Temperature Warning - Within 5° F. of alarm |
| 2 | Temperature Alarm - Out of temperature range |
| 4 | Battery Low |
| 8 | TBD |
| 16 | TBD |
| 32 | TBD |
| 64 | TBD |
| 128 | Sensor Never Found |

By utilizing domain specific models like the example above for sensing truck and trailer aspects, domain specific data models can be integrated into specifications such as IoTivity, AliJoyn, or other IoT related specifications.

The OpenWare wireless mid-range protocol has been enhanced to be more power efficient than other short range wireless protocols such as Bluetooth, Zigbee, ANT and other short range wireless protocols. One such enhancement is to send the body or raw data from the sensor along with the initial wakeup request on the network so that the relevant sensor data is sent in the initial transmission sequence along with the wakeup indication to initiate a transaction. This should require that the sensor data also be encrypted and/or obfuscated so that sensitive information cannot be intercepted during transmissions.

The OpenWare Sensor Device, Router and Gateway hardware is further enhanced so that sensors such as temperature, pressure, accelerometer, or any other sensor can be remotely calibrated wirelessly. This calibration is a key differentiator as no other Sensor Devices currently support remote calibration of the sensors on-board. These capabilities are in addition to features of the OpenWare product line mentioned in previously filed disclosures as well as in the hardware/sensor configurations listed below:

OpenWare Sensor Device Options (SD-Sensor type): Capable of monitoring ID and sensor readings with battery condition, reporting any changes at a preprogrammed time interval. These sensor packs are able to “send” data (transmitter) to the OpenWare Intelligent Routers and/or Intelligent Gateways for forwarding to either the Local host, Intranet or Internet database via IoT Platform. All models are available with a non-rechargeable coin cell battery offering 400 hours of continuous use, or with a rechargeable battery offering 250 hours of continuous use in the same form factor. All device options have a standard transmission range of 2000 feet line on wireless range with a four-phase commit per transmission to guarantee delivery.

### Blockchain Data Storage for IoT Implementations

The overall trading system technical architecture should implement a “blockchain” based transaction recording mechanism to reduce fraud and improve system reliability. According to Wiki: A blockchain—originally block chain—is a continuously growing list of records, called blocks, which are linked and secured using cryptography. Each block typically contains a hash pointer as a link to a previous block, a timestamp and transaction data. By design, blockchains are inherently resistant to modification of the data. A blockchain can serve as “an open, distributed ledger that can record transactions between two parties efficiently and in a verifiable and permanent way.” For use as a distributed ledger, a blockchain is typically managed by a peer-to-peer network collectively adhering to a protocol for validating new blocks. Once recorded, the data in any given block cannot be altered retroactively without the alteration of all subsequent blocks, which needs a collusion of the network majority.

Blockchains are secure by design and are an example of a distributed computing system with high Byzantine fault tolerance. Decentralized consensus has therefore been achieved with a blockchain. This makes blockchains potentially suitable for the recording of events, medical records, and other records management activities, such as identity management, transaction processing, documenting provenance, or food traceability.

Many aspects of the blockchain design are desirable for a commodity exchange and/or trading platform. However, a blockchain-based architecture isn't necessarily required to implement a carbon credit or expanded commodity exchange. Either form should support the notion of immediate buy/sell transactions, options, forwards and/or futures, and swaps.

A blockchain—originally block chain—is a continuously growing list of records, called blocks, which are linked and secured using cryptography. Each block typically contains a hash pointer as a link to a previous block, a timestamp and transaction data. By design, blockchains are inherently resistant to modification of the data. A blockchain can serve as “an open, distributed ledger that can record transactions between two parties efficiently and in a verifiable and permanent way.” For use as a distributed ledger, a blockchain is typically managed by a peer-to-peer network collectively adhering to a protocol for validating new blocks. Once recorded, the data in any given block cannot be altered retroactively without the alteration of all subsequent blocks, which needs a collusion of the network majority.

Blockchains are secure by design and are an example of a distributed computing system with high Byzantine fault tolerance. Decentralized consensus has therefore been achieved with a blockchain. This makes blockchains potentially suitable for the recording of events, medical records, and other records management activities, such as identity management, transaction processing, documenting provenance, or food traceability.

The first work on a cryptographically secured chain of blocks was described in 1991 by Stuart Haber and W. Scott Stornetta. In 1992, Bayer, Haber and Stornetta incorporated Merkle trees to the blockchain as an efficiency improvement to be able to collect several documents into one block.

The first distributed blockchain was then conceptualized by an anonymous person or group known as Satoshi Nakamoto in 2008 and implemented the following year as a core component of the digital currency bitcoin, where it serves as the public ledger for all transactions. Through the use of a peer-to-peer network and a distributed timestamping server, a blockchain database is managed autonomously. The use of the blockchain for bitcoin made it the first digital currency to solve the double spending problem without requiring a trusted administrator. The bitcoin design has been the inspiration for other applications.

The words block and chain were used separately in Satoshi Nakamoto's original paper in October 2008, and when the term moved into wider use it was originally block chain, before becoming a single word, blockchain, by 2016. In August 2014, the bitcoin blockchain file size reached 20 gigabytes. In January 2015, the size had grown to almost 30 gigabytes, and from January 2016 to January 2017, the bitcoin blockchain grew from 50 gigabytes to 100 gigabytes in size.

By 2014, “Blockchain 2.0” was a term referring to new applications of the distributed blockchain database. The Economist described one implementation of this second-generation programmable blockchain as coming with “a programming language that allows users to write more sophisticated smart contracts, thus creating invoices that pay themselves when a shipment arrives or share certificates which automatically send their owners dividends if profits reach a certain level.” Blockchain 2.0 technologies go beyond transactions and enable “exchange of value without powerful intermediaries acting as arbiters of money and information”. They are expected to enable excluded people to enter the global economy, enable the protection of privacy and people to “monetize their own information”, and provide the capability to ensure creators are compensated for their intellectual property. Second-generation blockchain technology makes it possible to store an individual's “persistent digital ID and persona” and are providing an avenue to help solve the problem of social inequality by “[potentially changing] the way wealth is distributed”. As of 2016, Blockchain 2.0 implementations continue to require an off-chain oracle to access any “external data or events based on time or market conditions [that need] to interact with the blockchain”.

In 2016, the central securities depository of the Russian Federation (NSD) announced a pilot project based on the Nxt Blockchain 2.0 platform that would explore the use of blockchain-based automated voting systems. Various regulatory bodies in the music industry have started testing models that use blockchain technology for royalty collection and management of copyrights around the world. [better source needed] IBM opened a blockchain innovation research centre in Singapore in July 2016. A working group for the World Economic Forum met in November 2016 to discuss the development of governance models related to blockchain. According to Accenture, an application of the diffusion of innovations theory suggests that in 2016 blockchains attained a 13.5% adoption rate within financial services, therefore reaching the early adopters phase. In 2016, industry trade groups joined to create the Global Blockchain Forum, an initiative of the Chamber of Digital Commerce.

In early 2017, the Harvard Business Review suggested that blockchain is a foundational technology and thus “has the potential to create new foundations for our economic and social systems.” It further observed that while foundational innovations can have enormous impact, “It will take decades for blockchain to seep into our economic and social infrastructure.”

A blockchain facilitates secure online transactions. A blockchain is a decentralized and distributed digital ledger that is used to record transactions across many computers so that the record cannot be altered retroactively without the alteration of all subsequent blocks and the collusion of the network. This allows the participants to verify and audit transactions inexpensively. They are authenticated by mass collaboration powered by collective self-interests. The result is a robust workflow where participants' uncertainty regarding data security is marginal. The use of a blockchain removes the characteristic of infinite reproducibility from a digital asset. It confirms that each unit of value was transferred only once, solving the long-standing problem of double spending. Blockchains have been described as a value-exchange protocol. This blockchain-based exchange of value can be completed more quickly, more safely and more cheaply than with traditional systems. A blockchain can assign title rights because it provides a record that compels offer and acceptance.

A blockchain database consists of two kinds of records: transactions and blocks. Blocks hold batches of valid transactions that are hashed and encoded into a Merkle tree. Each block includes the hash of the prior block in the blockchain, linking the two. Variants of this format were used previously, for example in Git. The format is not by itself sufficient to qualify as a blockchain. The linked blocks form a chain. This iterative process confirms the integrity of the previous block, all the way back to the original genesis block. Some blockchains create a new block as frequently as every five seconds. As blockchains age they are said to grow in height.

Sometimes separate blocks can be produced concurrently, creating a temporary fork. In addition to a secure hash based history, any blockchain has a specified algorithm for scoring different versions of the history so that one with a higher value can be selected over others. Blocks not selected for inclusion in the chain are called orphan blocks. Peers supporting the database have different versions of the history from time to time. They only keep the highest scoring version of the database known to them. Whenever a peer receives a higher scoring version (usually the old version with a single new block added) they extend or overwrite their own database and retransmit the improvement to their peers. There is never an absolute guarantee that any particular entry will remain in the best version of the history forever. Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

By storing data across its network, the blockchain eliminates the risks that come with data being held centrally. The decentralized blockchain may use ad-hoc message passing and distributed networking. Its network lacks centralized points of vulnerability that computer crackers can exploit; likewise, it has no central point of failure. Blockchain security methods include the use of public-key cryptography. A public key (a long, random-looking string of numbers) is an address on the blockchain. Value tokens sent across the network are recorded as belonging to that address. A private key is like a password that gives its owner access to their digital assets or otherwise interact with the various capabilities that blockchains now support. Data stored on the blockchain is generally considered incorruptible.

Every node or miner in a decentralized system has a copy of the blockchain. Data quality is maintained by massive database replication and computational trust. No centralized “official” copy exists and no user is “trusted” more than any other. Transactions are broadcast to the network using software. Messages are delivered on a best effort basis. Mining nodes validate transactions, add them to the block they are building, and then broadcast the completed block to other nodes. Blockchains use various time-stamping schemes, such as proof-of-work, to serialize changes. Alternate consensus methods include proof-of-stake and proof-of-burn. Growth of a decentralized blockchain is accompanied by the risk of node centralization because computer resources required to operate bigger data become more expensive.

The blockchain mechanism could be used for registering users of the IoT implementation, as well as registering all the equipment necessary to implement the carbon credit generation and monitoring software platform, potentially in a Cloud-computer based environment. One could foresee the blockchain implementation within a single Cloud-computing environment, or spanning across two or more Cloud-computing environments. If the blockchain implementation was spread across multiple Clouds, this would increase security as well as availability and stability of the entire system. All transactions could be recorded by the blockchain so that the entire IoT implementation benefits from the blockchain's benefits.

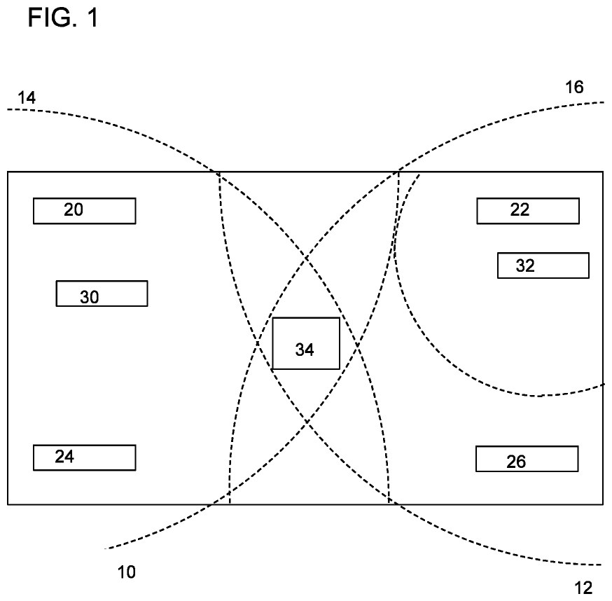

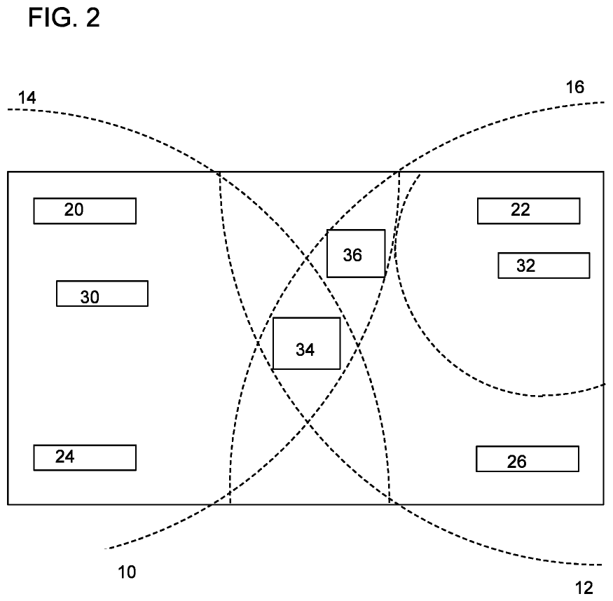

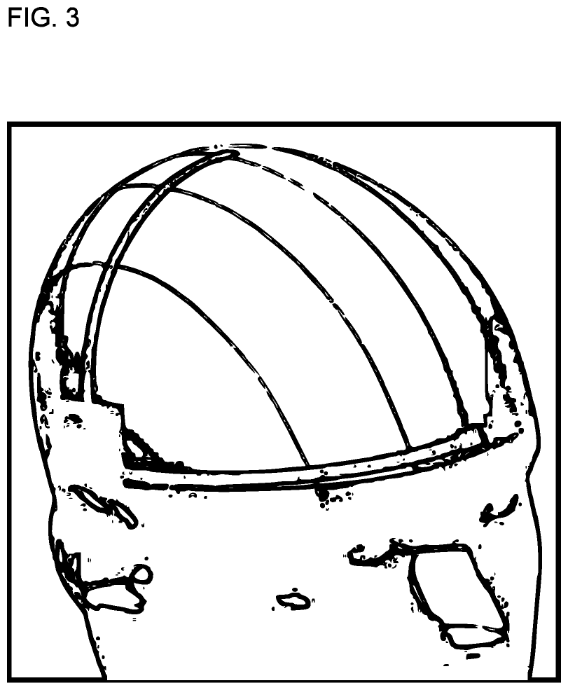

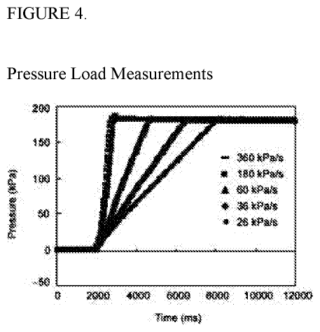

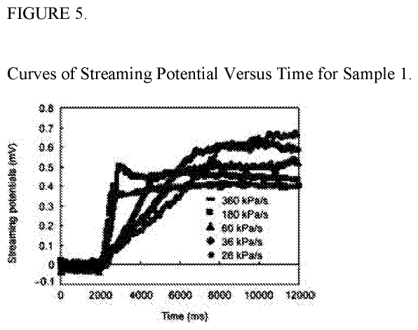

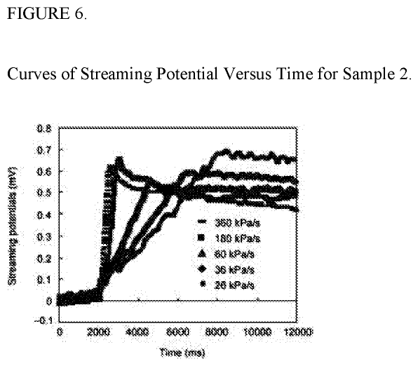

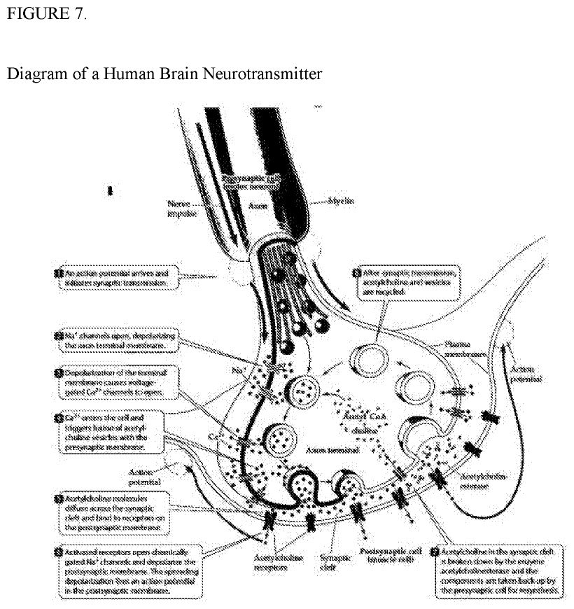

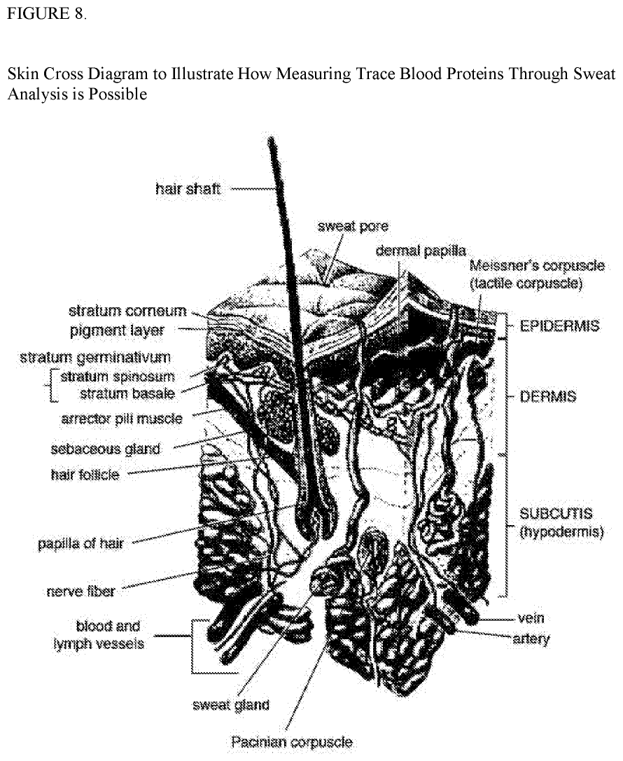

FIG. 1 shows an example “Internet-of-Things” hardware layout for a factory floor with edge hardware including sensor devices 30 and 32; edge routers 20, 22, 24, and 26; and an edge gateway 34 with cellular, satellite and/or LoRaWAN or SigFox capability built in for Internet access. FIG. 2 shows an example “Internet-of-Things” hardware layout for a factory floor with edge hardware including sensor devices 30 and 32; edge routers 20, 22, 24, and 26; and an edge gateway 34 with local WiFi gateway 36 for Internet access. FIG. 3 shows an example hardware design layout for combination sport performance monitoring headgear with audio communications capability.

### REFERENCES

1. ANDERSON J.e., ERIKSSON C., 1968, Electrical properties of wet collagen, Nature, 218, 166-68

2. ANDERSON J. e., ERIKSSON C., 1970, Piezoelectric properties of dry and wet bone, Nature, 227, 491-92

3. ASCENZI A., BENVENUTI A., 1977, Evidence of a state of initial stress in osteonic lamellae, J. Biomechanics, 10, 447-53

4. ASHERO G., GIZDULICH P., MANGO F., 1999, Statistical characterization of piezoelectric coefficient d23 in cow bone, J. Biomechanics, 32, 573-77

5. ASTBURY, W. T., 1933, Some problems in the X-ray analysis of the structure of animal hairs and other protein fibres, Trans. Famday Soc., 29, 193-211

6. ATHENSTAEDT H.) 1970, Permanent longitudinal electric polarization and pyroelectric behavior of the collagenous structures and nervous tissue in man and other verterbrates, Nature, 228, 830-34

7. AVDEEV Yu. A., REGIRER S. A., 1979, Mathematical model of bone tissue as a poroelastic piezoelectric material, Mekh. Kompozitnykh Materyalov, No.5, 851-55, in Russian

8. BASSET C. A. L., 1964, Bone biodynamics, cd. by H. M. Frost, Little & Brown, Boston, Mass.

9. BASSET C. A. L., 1965, Electrical effects in bone, Scient. Am., 213, 18-25 10. BASSETT C. A. L., 1968, Biological significance of piezoelectricity, Calc. Tiss. Res., 1, 252-272

11. BASSETT C. A. L., 1971, Biophysical principles affecting bone ˜tructure, in: The biochemist″) and physiology of bone, Vol. 3, 1-76, ed. by G.H. Bourne, 2nd Edition, Academic Press, New York

12. BASSET C. A. L., BECKER R. O., 1962, Generation of electric potentials by bone in response to mechanical stress, Science, 137, 1063-1064

13. BASSET C. A. L., PAWLUK R. J., BECKER R. O., 1964, Effects of electric currents on bone in vivo, Nature, 204, 652-654

14. BAZHENOV V. A., 1961, Piezoelectric properties of wood, Consultants Bureau, New York, N. Y.

15. BAZHENOV V. A., KONSTANTINOVA V. P., 1950, P'iezoelektricheskiyesvoystva drevesiny, Doklady Akad. Nauk SSSR, 71, 283-286

16. BEAN B. P., 1989, Classes of calcium channels in vertebrate cells, Ann. Rev. Physiol., 51, 367-384 750. J. J. TELEGA, R. WOJNAR

17. BECKER R. O., BASSET C. A. L., BACHMAN C. H., 1964, Bioelectrical factors controlling bone structure, Bone biodynamics, cd. by H. M. Frost, Little Brown, Boston, 209-232

18. BERRIDGE M. J., 1993, Inositol trisphosphate and calcium signalling, Nature, 361,315-325

19. BHAGAVANTAM S., 1966, Crystal symmetry and physical properties, Academic Press, London

20. BIELSKI W., TBLECA J. J., 1997, Effective properties of geomateriais: rocks and porous media, Publ Institute of Geophysics Polish Academy of Sciences, A-26, 285, Warsaw

21. BlOT M. A., 1955, Theory of elasticity and consolidation for a porous anisotropic solid, J. Appl. Phys., 26, 182-185

22. BLACK.l., KOROSTOFF E., 1974, Strain-related potentials in living bone, N. Y. Acad. Sci., 238, 95-120

23. BOURNE G. H., 1971, Phosphate and calcification, in: The biochemistry and physiology of bone, Vol. 2, ed. by G. H. Bourne, Academic Press, New York, 79-120

24. BRADIN M″ BAIRSTOW A. G., BEIDER I., RITTER B. G., 1966, Electrical and piczoclectrical properties of dental hard tissues, Nature, 212, 1565-1566

25. BRADY M. M., SYMONS S. A., STUCHLY 8. S., 1981, Dielectric behavior of selected animal t issues in vitro at frequencies from 2 to 4 GHz, IEEE Trans. Biomed Engng., BME-28, 305-307

26. BRIGHTON C. T., BLACK J., POLLACK S. R., 1979, Electrical properties of bone and cartilage, Grunc and Stratton, New York

27. BRIGHTON C. T., F ISHER J. R. J R, L EVINE S. E., CORSETTI J. R., REILLY T., LANDSMAN A. S., WILLIAMS J. L., THIBAULT L. R., 1996, The biochemical pathway mediating t he proliferative response of bone cells to a mechanical stimulus. A beginning to an understanding of Wolff s Law, J. Bone Joint Surg. Am 78, 1337-47

28. BRIGHTON C. T., SCHAFFER J. L., SHAPIRO D. B., TANG J. J. S., CLARK C. C., 1991, Proliferation and macromolecular synthesis by rat calvarial bone cells grown in various oxygen tension, J. Orthop. Res., 9, 847-854

29. BRIGHTON C. T., SENNETT B. J., FARMER J. C., ET AL., 1992, The inositol phosphate pathway as a mediator in the cell proliferative response of rat calvarial bone cells to cyclical biaxial mechanical strain, J. Orthop. Res., 10, 385-393

30. BUR A. J., 1975, Piezoelectric measurements on bone as a function of temperature and humidity, Bull. Am. Phys. Soc., 20, 483 PIEZOELECTRIC EFFECTS IN BIOLOGICAL TISSUES 751

31. BUR A. J.) 1976, Measurements of the dynamic piezoelectric properties of bone as a function of temperature and humidity, j. Biomechanics, 9, 495-507

32. BUSCH S., DOLHAINE H., DUCHESNE A., HEINZ S″ HOCHREIN O., LAERI F., PODEBRAD 0., VIETZE V., WEILAND T″KNIEP R., 1999, Biomimetic morphogenesis of fluo rapatite-gelatin composites: fractal growth, the question of intrinsic electric fields, core/shell assemblies, hollow spheres and reorganization of denaturated collagen, Bur, j. [nory. Chern., 10, 1643-1653

33, CADY w. e., Piezoelectricity, Dover, N.Y. 1964

34, CHAKKALAKAL D. A., JOHNSON M. W″ HARPER R. A., KATZ J. L., 1980, Dielectric properties of fluid saturated bone, IEEE ltans. Biomed Engng., BME-27,95-100

35. COCHRAN C. V. B., PAWLUK R. J., BASSETT C. A. L., 1968, Electromechanical characteristics of bone under physiologic moisture conditions, Glin. Orthop″ 58, 249-270

36. COLE K. S., LI CH. -L., BAK A. F″ 1969, Electrical analogues for t issues, Experimental Neurology, 24, 459-473

37. COOK H. F., 1941, The dielectric behaviour of some types of human tissue at microwave frequencies, Brit, J. Appl. Phys., 2, 295-304

38. CORSETTI J. R., LEVINE S. E., POLLACK S. R., BRIGHTON C. T., 1992, Enhanced proliferation of cultured bone cells by a capacitevely coupled electric field, Trans, Bioelec, Repair and Growth Soc., 11, 36

39. COWIN S. C. (EDIT.), 2001, Bone Mechanics Handbook, CRC Press, Boca Raton

40. COWIN S. C., MOSS-SALENTIJN L., Moss M. L., 1991, Candidates for the mechanosensory system in bone, J. Biomech. Engng., 113, 191-197

41. CROLET J. M″ AOUBIZA B., MEUNIER A″ 1993, Compact bone: numerical simulation of mechanical characteristics, j, Biomechanics, 26, 677-687

42. DAINORA J., 1964, Piezoelectric properties of bone, M,Sc. thesis, West Virginia University, Morgantown, W. Va.

43. DATE M., 1972, Piezoelectric constant in dispersed system8, Rept. Progr. Po˜lymer Phys. Japan, 15, 385-387

44, DAVIDSON R. M., TATAKIS D. W., AUERBACH A. L″ 1990, Multiple forms of mechanosensitivc ion channels in osteoblast-like ceil, Pjlij,gers Arch., 416, 646-651

45, DAWSON T. W., STUCHLY M. A., CAPUTA K., SASTRA A., SHEPARD R. B., KAVET R″ 2000, Pacemaker interference and low-frequency electric induction in humans by external fields and electrodes, IEEE Trans. Biomed Eng” 47, 1211-1218 752 J. J. TELEGA, R. WOJNAR

46. DEMIRAY H., GihELSU N., 1977, A mixture model for wet bones—I theory, Int. J. Engng Sci., 15, 707-718

47. ENCYCLOPAEDIA BRITANNICA, 1959, Vol. 3, William Benton Publisher, Chicago-London-Toronto, item: bone

48. ERIKSSON C., 1974, Streaming potentials and other water—dependent effects in mineralized tissue, N Y Acad. Sci., 238, 321-338

49. ERIKSSON C., 1976, Electrical properties of bone, in: The biochemistry and physiology of bone, VoL 4, ed. by G. H. Bourne, Academic Press, New York, 329-384

50. FERRIER J., Ross S. M., K ANEHISA J., AUBIN J. E., 1986, Osteoclasts and osteoblasts migrate in opposite directions in response to a constant electrical field, J. Cell. Physiol., 129, 283-288

51. FREEMAN J. R., 1967, Dielectric properties of mineralized t issues, TIuns. New York Acad. Sci, division of phys. scies, 29, 623-633

52. FROST H. M., 1973, Bone remodeling its relationship to metabolic bone diseases, Orthopaedic lectures, Vol. III, Charles C. Thomas, Springfield, III

53. FUKADA E., 1968a, Mechanical deformation and electrical polarization in biological substances, Biorheology, 5, 199-208

54. FUKADA E., 1968b, Pie7.oelectricity as a fundamental property of wood, Biol′heology, 5, 199-208

55. FUKADA E., 1968c, Piezoelectricity in polymers and biological materials, ULtrasonics, 6, 229-234

56. FUKADA E., 1974, Piezoelectric properties of organic polymers, N Y. Acad. Sci., 238, 7-25

57. FUKADA E., H ARA K, 1969, Piezoelectric effect in blood vessel walls, J. Phys. Soc. Japan, 26, 777-780

58. FUKADA E., TAKASHITA S., 1971, Piezoelectric constant in oriented {3 form polypeptides, Jap. J. AppL Phys., 10,722-726

59. FUKADA E., YASUDA l., 1957, On the piezoelectric effect of bone, J. Phys. Soc. Japan, 12, 1158-1162

60. FUKADA E., YASUDA I., 1959, Progres in Polymer Physics in Japan, 2, 101

61. FUKADA E., YASUDA I., 1964, Piezoelectric effects in collagen, Jap. J. Appl. Physics, 3, 117-121

62. GEIGER R. V., BERK B. C., ALEXANDER R. W., NEREM R. M., 1992, Flowinduced calcium transients in single endothelial cells; spatial and temporal analysis, Am. J. Physiol., 262, CI411-C1417 PIEZOELECTRIC EFFECTS IN BIOLOGICAL TISSUES 753

63. GJELSVIK A., 1973, Bone remodelling and piezoelectricity—I, II, J. Biomechanics, 6, 69-77, 187-193

64. GOES S. C., FIGUEIRO S. D., DE PAIVA J. A. C., SOr.lBRA A. S. B., 1999, Piezoelectric and dielectric properties of collagen films, Phys. Status Solidi A, 176, 1077-83

65. GUNDJIAN A. A., CHEN H. L., 1974, Standardization and interpretation of the electromechanical propertie˜of bone, IEEE Trans. Biomed Engng., BME-21, 177-182

66. GRODZINSKY A. J., 1983, Electrochemical and physicochemical properties of connective tissue, CRC Critical Reviews in Biomedical Engineering, 9, 133-199

67. GROSS D., WILLIAMS W. S., 1982, Streaming potential and the electromechanical response of physiologically moist bone, J. Biomechanics, 15, 277-295

68. GRYNKIEWICZ R. M., POENIE M., TSIEN KY., 1985, Flow-induced calcium transients in single endothel ial cells: spatial and temporal analysis, J. Biol Chem., 280, 6, 3440-3450

69. GUZELSU N., 1978, A piezoelectric model for dry bone tissue, J. Biomechanics, 11, 257-267

70. GUZELSU N., DEMIRAY H., 1979, Recent advances Electromechanical properties and related models of bone tissues A review, Int. J. Engng Sci., 17, 813-851

71. GUZELSU N., SAHA S., 1984, Electro-mechanical behavior of wet bone˜part I: theory, J. Biomech. Engng., 106, 249-261

72. GUZELSU N., SAHA S., 1984, Electro-mechanical behavior of wet bone—part II: wave propagation, J. Biomech. Engng., 106, 262-271

73. HE Y., GRINELLlF., 1994, Stress relaxation of fibroblasts activates a cyclic AMP signaling pathway, J. Cell Biol., 126, 2, 457-464

74. HERRING C. M., 1971, in: The biochemistry and physiology of bone, Vol. 1, cd. by G. H. Bourne, pp. 127-189, 2nd edition, Academic Press, New York

75. HILCZER B., MALECKI J., 1986, Electrets, PWN Warszawa and Elsevier Amsterdam

76. HOLLAND R., 1967, Representation od dielectric, elastic and piezoelectric losses by complex coefficients, IEEE Trans. Sonies Ultrason., SU-14, 18-20

77. HOLMES D. J. S., 1979, Quasi-hexagonal molecular packing in collagen fibrils, Nature, 282, 878-880

78. HOUSE S″ 2000, Applied electric field in the treatment of bone fractures, last modified: Oct. 23, 2000, http://www.wpi.edu/grovers/101 PH330 1/emtharpy/Sally House/Sally House.html 754 J.J. TELEGA, R. WOJNAR

79. HUNG C. T., ALLEN F. D., POLLACK S. R., BRIG HTON C. T., 1996a, What is the role of the convective current density in the real-time calcium response of cultured bone cells to fluid flow?, J. Biomechanics, 29, 1403-1409

80. HUNG C. T., ALLEN F. D., POLLACK S. R., BRIGHTON C. T., 1996b, Intracellural Ca2+ stores and extracellular Ca2+ are required in the real-time Ca2+ response of bone cel is experiencing fluid flow, J. Biomechanics, 29, 1411-1417

81. HUNG C. T., POLLACK S. R., REILLY T. M., BRIGHTON C. T., 1995, Realtime calcium response of cultured bone cells to fluid flows, GUn. Orthop., 313, 256-269

82. HUNTER R. J., 1981, Charge and potential distribution aat intefaees, in: Zeta potential in colloid science—principles and applications, Academic Press, London-New York-Orlando, pp. 11-58

83. JENDRUCKO R. J., CHENG C. J., H YMAN W. A., 1977, The distribution of induced electrical acitivity in bent long bone, J. Biomechanics, 10, 493-503

84. J OHNSON M. W., KATZ J. L., 1987, Electromechanical effects in bone, in: Handbook of Bioengineering, Edit. R. Skalak and S. Chien, Me Graw Hill, New York, 3.1-3.11

85. JOHNSON M. W., CHAKKALAKAL D. A., HARPER R. A., KATZ J. L., 1980a, Comparison of the electromechanical effects in wet and dry bone, J. Biomechanics, 13, 437-442

86. JOHNSON M. W., WILLIAMS W. S., GROSS D., 1980b, Ceramic models for piezoelectricity in dry bone, J. Biomechanics, 13, 565-573

87. JONES D. B., BING MANN D., 1991, How do osteoblasts respond to mechanical stimulation?, Cells materials, 1, 329-340

88. KATZ J. L., 1971, Hard tissue as a composite material. L Bounds on the elastic behavior, J Biomechanics. 4, 455-473

89. KIETIS B. P., LINCE D., PAKALNIS S. and VALKUNAS L., 1998, Piezoelectric model of energy conversion in bacteriorhodopsin, Lith. Phys. 1, 38, 270-5. Translation of: Liet. Fiz. Z., 38, 313-19 (1998)

90. KOROSTOFF E., 1977, Stress generated potentials in bone: relationship to piezoelectricity of collagen, J. Biomechanics, 10,4 1-44

91. Korostoff E., 1979, Linear piezoelectric model for characterizing stress generated potentials in bone, J. Biomechanics, 12, 335-347

92. KOSTERICH J. D., FOSTER K. R., POLLACK S. R., 1984, Dielectric properties of fluid saturated bone: effect of variation in conductivity of immersion fluid, IEEE Trans. Biomed. Engng., 31, 369-374

93. KUDRIAVTSEV B. A., 1978, Mechanics of piezoelectric mater ials, in: Itogi Nauki i Tekhniki. Mekhanika tverdogo dejormiruemogo tela, 14, 5-66, in Russian PIEZOELECTRIC EFFECTS IN BIOLOGICAL TISSUES 755

94. KUMMER B. K. F., 1972, in: Biomechanics, ed. by Y C. Fung, N. Perrone and M. Anliker, Prentice-Hall, New York, 237-271

95. LAKES R. S., HARPER P. A., KATZ J. L., 1977, Dielectric relaxation in cortical bone, J. AppL Phys., 48, 808-811

96. LANDAU L. D., LIFSHITS E. M., 1982, Elektrodynamics of continuous media, Nauka, Moskva, in Russian

97. LANG S. B., 1966, Pyroelectric effect in bone and tendon, Nature, 212, 704-705

98. LANG S. B., 1969, Thermal expansion coefficients and the primary and secondary pyroelectric coefficients of animal bone, Nature, 224, 798-799

99. LANYON L. E., 1992, Osteocytcs, strain detection, bone modeling and remodeling, Calci/. Tissue Int, 53, Suppl. 1, S102-S107

100. LEKSZYCKI T., TELEGA J. J., 2002, Progress in functional adaptation of tissues and remodelling, Part I and II, Eng, Trans″ in press

101. LI BOF′F A. R., FURST M″ 1974, Pyroelectric effects in collagenous structures, N Y. Acad. Sci., 238, 26-35

102. LIBOFF A. R., SHAMOS M. H., 1973, Solid state physics of bone, in: Biological mineralization, ed. by L Zipkin, Wiley, New York, Chapter 14, 335-395

103. LIBOFF A. R., SHAMOS M.H″ DEVIRGILIO W″ 1971, The piezoelectric moduli of bone, 15th Ann, Biophys, Soc. Meet″ New Orleans

104. LORICH D. G″ BRIG HTONE C. T., CORSETTI J. R″ P OLLACK S. R., 1993, Role of prostaglandin E2 on bone cell proliferation in response to a capacitevcly coupled electric field, Trans, Ort/wp, Res, Soc” 18, 179

105. MARINO A. A., BECKER R. O., 1975, Piezoelectricity in hydrated bone and tendon, Nature, 253, 627-628

106. MARINO A. A″ ROSSON J., GONZALEZ E., JONES L″ FUKADA E.) 1988, Quasi-static charge interaction in bone, J. Electrostatics, 21, 347-360

107. MAROUDAS A., 1968, Physicochemical properties of cartilage in the light of ion exchange theory, Biophysical J″ 8, 575-594

108, MARTIN A. J. P., 1941, Triboelectricity in wood and hair, Proc, Phys. Soc″ 53, 186-189

109. McELHANEY J. H., 1967, (1968) T he charge distribution of the human femur due to load, j. Bone and Joint SurgenJ, 49-A, 1561-1571

110, McLEAN F. e., 1955, Bone, Scientific American, 192,2,84-91

111. MCLEOD K. J., DONAHUE H. J., FONTAINE M. A., R UBIN C. T., 1993, Cell density effects on t he interaction of electric fields with cells in vitro, in: Electricity and magnetism in biology and medicine, ed. by M. Blank, San Francisco Press, San Francisco, pp. 291-294

756. J. J. TELEGA, R. WOJNAR

112. MICHEL e.c., 1988, Capillary permeability and how it may change, J. Physiol., 404, 1-29

113. MINDLIN R. D., 1961, On the equations of motion of piezoelectric crystals, in: Problems of continuum mechanics, ed. by J. R. M. Radok, Society for Industrial and Applied Mathematics, Philadelphia, pp. 282-290

114. PELTIER, L. F., 1981, A brief hil:itorical note on the use of electricity in the treatment of fractures, Glin. Orthop., 161, Nov.-Dec. 4-7

115. PETHIG R., 1979, Dielectric and electronic properties of biological materials, J. Wiley, Chichester

116. PETROY N., 1975, Electro-mechanical interactions in physiologic wet bones, Bulgarian Academy of Sciences, Biomechanics, 2, 31-42

117. PFEIFFER B. H., 1977a, Local piezoelectric polarization of human cortical bone as a function of stress frequency, .I. Biomechanics, 10, 53-57

118. PFEIFFER B. H., 1977b, A model to estimate the piezoelectric polarization in the osteon system, J. Biomechanics, 10, 487-492

119. PIEKARSKI K, 1973, Analysis of bone as a composite material, Int. J. Engng Sci., 11,557-565

120. PIENKOWSKI D., POLLACK S. R., 1983, The origin of stress-generated potentials in fluid saturated bone, J. Orthop. Res., 1, 30-41

121. POLLACK S. R., PETROV N., SALZSTEIN R., BRANKOV G., BLAGOEVA R., 1984, An anatomical model for streaming potentials in osteons, I Biomechanics, 17, 627-636

122. R AMACHANDRAN G. N., KARTHA G.) 1954, Structure of coHagan, Nature, 174, 269-270

123. REGLING G., 2000, Conception of a bioelectromagnetic signal system via the collagen fibril network; Biochemical conclusions and underlying coherent mechanism. 1. Solid state effects and hierachical bioelectrical regulation, Electroand Magnetobiology, 19, 149-161 II. Energetic aspects, acid and neutral proteases, and t he phenomenon of coherence, ibid, 163-175

124. REICH K. M., FRANGOS J. A., 1993, Protein kinase C mediates flow-induced prostaglandi n E-2 production in osteoblasts, Calcif. Tissue Int., 52, 62-66

125. REICH K. M., GAY C. V., FRANGOS J. A., 1990, Fluid shear stress as a mediator of osteoblast cyclic adenosine monophosphate production, J. Cell. Physioi., 143, 100-104

126. REINISH G. B., NOWICK A. S., 1975, Piezoelectric properties of bone as functions of moisture content, Nature, 253, 626-627 PIEZOELECTRIC EFFECTS IN BIOLOGICAL TISSUES 757

127. RICE J. R., CLEARY M. P., 1976, Some basic stress diffusion sol utions for fluid saturated clastic porous media with compressible constituents, Rev. Geophys. Space Phys., 14, 227-241

128. RUDNICKI J. W., 1985, Effect of pore fluid diffusion on deformation and failure of rock, Mechanics of Geomaterials, cd. by Z. Bazant, John Wiley and Sons, 315-347

129. SADOSHIMA J. -l., TAKAHASHI T., JAHN L., I ZUMO S., 1992, Role of mechanosensitive ion channels, cytoskeleton, and contractile activity in stretch˜jnduced immediate-early gene expression and hypertrophy of cardiac myocytes, Proc. Nall. A cad Sci., 89, 9905-9909

130. SALZSTEIN R. A., POLLACK S. R., 1987, Electromechanical potential in cortical bone II. Experimental analytlis, I Biomechanics, 20, 271-280

131. SALZSTEIN R. A., POLLACK S. R., MAK A. F. T., PETROV N., 1987, Electromechanical potentials in cortical bone—I. A continuum approach, J. Biome˜chanics, 20, 261-270

132. SASAKI N., OOAJIMA S., 1996, Stress˜strain curve and Young's modulus of a collagen molecule as determined by the X-ray diffraction technique, J. Biome˜chanics, 29, 655˜658

133. SATCHER R. L. JR, BUSSOLARI S.R., GIMBRONE M. A. JR, DEWEY F. e. JR, 1992, The distribution of forces on model endothelium using computational fluid dynamics, J Biamech. Engng., 114, 309-316

134. SCHWAN H. P., 1957, ElecLrica.l properties of tissue and cell suspensions, in: Advances in Biological and Medical Physics, vol. 5, Academic, New York, 147-209

135. SCOTT G. C., KOROSTOFF E., 1990, Oscillatory and step response: electromechanicl phenomena in human and bovine bone, J. Biomechanics, 23, 127-143

136. SHAMOS M. H., LAVINE L. S., 1964, Physical bases for bioelectric effect in mineralized tissues) Clinical Orthopaedics and Related Research, 35, 177˜188

137. SHAMOS M. H., LAVINE L. S., SHAMOS M. L, 1963, Piezoelectric effect in bone, Natul'e, 197,81-81

138. SHUBNIKOV A.V., 1946, Piezoelectric textul″es, Izd. AN SSSR, in Russian

139. SHUBNIKOV A. V., BELOV N. V., 1964, Coloured symmetry, Pergamon Press

140. SILLARS R. W., 1937, The properties of a dielectric containing semi˜conducting particles of various shapes, J. Instn. EleciT. Engrs, London, 80, 378-394

141. SPIRT A. A., POLLACK S.R., 1993, Age-related change in the zeta potential of bone and its influence upon endogenous electrical field strength, in: Electricity and magnetism in biology and Medicine, ed. by M. Blank, San Francisco Press, San Francisco, 693-697

758 J. J. TELEGA, R. WOJNAR

142. STUCHLY M. A., STUCHLY S. S., 1980, Dielectric properties of biological substances, tabulated, J. Microwave Power, 15, 19-26

143. TELEGA J. J., 1991, Piezoelectricity and homogenization. Application to biomechanics, in: Continuum Models and Discrete Systems, vol. 2, ed. by G. A. Maugin, 220-229, Longman, Essex

144. TELEGA J. J., WOJNAR R., 1996, Flow of conductive fluids through poroeiastic media with piezoelectric properties, Fluid-Structure Interactions in Biomechanics, 10-13th April, Imperial College, London SW7 2AZ UK

145. TELEGA J. J ″ WOJNAR R., 1998, Flow of conductive fluids through poroeiastic media with piezoelectric properties, J. Theor. Appl. Meeh., 36, 775-794

146. TELEGA J. J., WOJNAR R., 2000, Flow of electrolyte through porous piezoelectric medium: macroscopic equations, e. R. Acad. SCi., Paris, 328, Serie ITb, 225-30

147. TSAY R. -Y., WEINBAUM S., 1991, Viscous flow in a channel with periodic cross-bridging fibers: exact solution and Brinkman approximation, J. Fluid Meeh., 226, 125-148

148. UKLEJEWSKJ R., 1993, Electromechanical potentials in a fluid-filled cortical bone: initial stress state in ostconic lamellae, piezoelectricity and streaming potential roles—a theory, Biocybernetics and Biomedical Engng., 13,97-112

149. UKLEJEWSKI R., 1994, Initial piezoelectric polarization of cortical bone matrix as a determinant of the electrokinetic potential Zeta oft hat bone osteonic lamella as mechanoelectret, 1. Biomechanics, 27, 991-992

150. WARNER M., TERENTEV E. M., 1999, The coupling of chiral chains to mechanical distortions in elastomers, Proc. R. Soc. Lond., A 455, 3629-44

151. WEINBAUM S., COWIN S. C., ZENG Yu, 1994, A model for the excitation of osteocytes by mechanical loading-induced bone fluid shear stresses, J. Biomechanics, 27, 339-360

152. WILKINSON S. J HUKINS D. W. L., 1999, Determination of collagen fibril structure and orientation in connective tissues by X-ray diffraction, Radiat. Phys. Chern., 56, 197-204

153. WILLIAMS W. S., 1974, Sources of piezoelectricity in tendon and bone, eRe Critical Reviews in Bioengineering, 95-118

154. WILLIAMS W. S., BREGER L., 1974, Analysis of stress distribution and piezoelectric response in cantilever bending of bone and tendon, Ann. N Y. Acad. Sci., 238, 121-130

155. WILLIAMS W. S., BREGER L., 1975, Piezoelectricity in tendon and bone, J. Biomechanics, 8, 1-6

156. W ILLIAMS W. S., BREGER L., JOHNSON M., 1975, Ceramic models for study of piezoelectricity in solids, J. Am. Ceram. Soc., 58, 415-417 PIEZOELECTRIC EFFECTS IN BIOLOC1CAL TISSUES 759

157. WILLIAMS J. L., IANNOTI J. P., HAM A., BLEUIT J., CHEN J. H., 1994, Effects of fluid shear titress on bone cells, Biorheology, 31, 161-168

158. WOJNAR R., TELEGA J. J., 1997, Electrokinetics in dielectric porous media, Problems of environmental and damage mechanics, Proceedings of the XXXI Polish Solid Mechanics Conference, Sep. 9-14, 1996, ed. by W. Kosinski, R. de Boer, D. Gross, IPPT PAN, Warszawa

159. WOLFF J., 1892, Das Gesetz der Transformationen der Knochen, Hirschwald, Berlin

160. YASUDA I., NOGUCHI K.) SATA T., 1955, Dynamic callus and electric callus, The Journal of Bone and Joint Surgery, 37 A, 1292-1293

161. YOON H. S., KATZ J. L., 1976, Ultrasonic wave propagation in human cortical bone—III. Piezoelectric contribution, J. Biomechanics, 9, 537-540

162. ZHANG D. S., WEINBAUM S., COWIN S. C., 1998, On the calculation of bone pore water pressure due to mechanical loading, Int. J. Solids Structures, 35, 4981-4997

163. ZHELUDEV 1.8., 1974, Piezoelectricity in textured media, Solid State Physics, 29, 315-359

164. Currey J D. The many adaptations of bone. J Biomech, 2003, 36(10): 1487-1495

165. Alma A C, Grodzinskyc A J. Relevance of collagen piezoelectricity to “Wolff's Law”: A critical review. Med Eng Phys, 2009, 31(7): 733-741

166. Burger E H, Klein-Nulend J, Smit T H. Strain-derived canalicular fluid flow regulates osteoclast activity in a remodelling osteon—a proposal. J Biomech, 2003, 36(10): 1453-1459

167. Ryan C R, Henry J D. From streaming potentials to shear stress: 25 years of bone cell mechanotransduction. J Orth Res, 2009, 27(2): 143-149

168. Pienkowski D, Pollack S R. The origin of stress-generated potentials in fluid-saturated bone. J Orth Res, 1983, 1(1): 30-41

169. Lemaire T, Naïli S, Rémond A. Study of the influence of fibrous pericellular matrix in the cortical interstitial fluid movement with hydroelectrochemical effects. J Biomech Eng, 2008, 130(1): 1-11

170. Cowin S C. Bone poroelasticity. J Biomech, 1999, 32(3): 217-238MathSciNet

171. Anderson J C, Eriksson C. Electrical properties of wet collagen. Nature, 1968, 218(5137): 166-168

172. Hong J W, Ko S O. Intraosseous pressure and strain generated potential of cylindrical bone samples in the drained uniaxial condition for various loading rates. J Mater Sci: Mater Med, 2008, 19(7): 2589-2594

173. Guzelsu N, Wienstien C, Kotha S P. A new streaming potential chamber for zeta potential measurements of particulates. Rev Sci Inst, 2010, 81(1): 1-6

174. Qin Y X, Lin W, Rubin C. The pathway of bone fluid flow as defined by In vivo intramedullary pressure and streaming potential measurements. Ann Biomed Eng, 2002, 30(5): 693-702

175. Lemaire T, Naïli S, Rémond A. Multiscale analysis of the coupled effects governing the movement of interstitial fluid in cortical bone. Biomech Model Mechan, 2006, 5(1): 39-52

176. Zhu J, Davidson C, Xuan X. Flow rate-modified streaming effects in heterogeneous microchannels. Microfluid Nanofluid, 2008, 5(6): 733-740

177. Gururaja S, Kim H J, Swan C C, et al. Modeling deformation-induced fluid flow in cortical Bone's canalicular-lacunar system. Ann Biomed Eng, 2005, 33(1): 7-25

178. Mak A F T, Zhang J D. Numerical simulation of streaming potentials due to deformation-induced hierarchical flows in cortical bone. J Biomech Eng, 2001, 123(1): 66-70

179. Quenneville E, Binette J S, Garon M, et al. Fabrication and characterization of nonplanar microelectrode array circuits for use in arthroscopic diagnosis of cartilage diseases. IEEE Trans Biomed Eng, 2004, 51(12): 2164-2173

180. Garon M, Legare A, Guardo R, et al. Streaming potentials maps are spatially resolved indicators of amplitude, frequency and ionic strength dependant responses of articular cartilage to load. J Biomech, 2002, 35(2): 207-216 181. Xu L Y, Hou Z D. Influence of loading rate on streaming potentials in Bone. Exp Mech, 2009, 24(4): 320-326

1. (canceled)

2. (canceled)

3. A method of communication by a sensor-equipped Internet-connected device on a blockchain platform, comprising:
receiving data from the sensor;
determining a trigger event as a function of the sensor data;
upon the trigger event occurring, transmitting the sensor data to a computing node via the Internet, wherein the computing node that is part of a collection of computing nodes in a distributed network, each of the computing nodes working to maintain a secure blockchain;
at the computing node in communication with the Internet-connected device, receiving the sensor data transmitted from the Internet-connected device;
adding at least one data block to the blockchain ledger, the added block containing information associated with the sensor data;
continuing to maintain the secure blockchain.

4. The method of claim 1, wherein the Internet-connected device transmits the sensor data only when the trigger event occurs.

5. The method of claim 4, wherein the Internet-connected device transmits the sensor data only intermittently instead of continuously.

6. The method of claim 4, wherein the Internet-connected device transmits the sensor data only when the sensor data changes from previous measurements by the sensor.

7. The method of claim 1, wherein the sensor is a heat sensor and the sensor data is heat measurements.

8. The method of claim 1, wherein the sensor is an electrical sensor.

9. The method of claim 8, wherein the electrical sensor is a voltage sensor or current sensor, and the sensor data is voltage measurements or current measurements, respectively.

10. The method of claim 1, wherein the sensor is a magnetic field sensor and the sensor data is magnetic field emission measurements.

11. The method of claim 1, wherein the sensor is a visible or infrared light sensor, and the sensor data is light intensity measurements.

12. The method of claim 1, wherein the sensor is an accelerometer and the sensor data is acceleration measurements.

13. The method of claim 1, wherein the sensor is an piezoelectric sensor and the sensor data is pressure, shock, or vibration measurements.

14. The method of claim 1, wherein the sensor is a chemical sensor.

15. The method of claim 1, wherein the Internet-connected device is a wearable athletic equipment.

16. A system of communication for Internet-connected devices on a blockchain platform, comprising:
(a) an Internet-connected device comprising a sensor;
(b) a computing node that is part of a collection of computing nodes in a distributed network, each of the computing nodes working to maintain a secure blockchain;
(c) wherein the Internet-connected device communicates with the computing node via the Internet and is programmed to perform operations comprising:
receiving data from the sensor;
determining a trigger event as a function of the sensor data;
upon the trigger event occurring, transmitting the sensor data to the computing node via the Internet;
(d) wherein the computing node is programmed to perform operations comprising:
receiving the sensor data transmitted from the Internet-connected device;
adding at least one data block to the blockchain ledger, the added block containing information associated with the sensor data;
continuing to maintain the secure blockchain.

17. The method of claim 16, wherein the Internet-connected device transmits the sensor data only when the trigger event occurs.

18. The method of claim 17, wherein the Internet-connected device transmits the sensor data only intermittently instead of continuously.

19. The method of claim 17, wherein the Internet-connected device transmits the sensor data only when the sensor data changes from previous measurements by the sensor.

20. The method of claim 16, wherein the sensor is a heat sensor and the sensor data is heat measurements.

21. The method of claim 16, wherein the sensor is an electrical sensor.

22. The method of claim 21, wherein the electrical sensor is a voltage sensor or current sensor, and the sensor data is voltage measurements or current measurements, respectively.
